(19) United States
(12) Patent Application Publication
(10) Pub. No.: US 2026/0170874 A1
(43) Pub. Date: Jun. 18, 2026

(54) Aircraft Monitoring System

(71) Applicant: Textron Aviation Inc., Wichita, KS (US)

(72) Inventors: Joshua Lawrence Bell, Wichita, KS (US); Paul Stokholm Warren, Valley Center, KS (US); Zachary Michael Mohr, Wichita, KS (US); Jonathan Lynn Kaufman, Park City, KS (US); Steffen Brown, Mundelein, IL (US)

(21) Appl. No.: 19/425,414

(22) Filed: Dec. 18, 2025

Related U.S. Application Data
(60) Provisional application No. 63/735,542, filed on Dec. 18, 2024.

(51) Int. Cl. G06V 40/20; B64D 11/00; B64D 11/06; G06T 7/50; G06T 7/73; G06V 20/52; G06V 20/59; G06V 40/16; G10L 15/08

(52) U.S. Cl. CPC G06V 40/28; B64D 11/00155; B64D 11/0639; G06T 7/50; G06T 7/73; G06V 20/52; G06V 20/597; G06T 2207/10016; G06T 2207/30201; G06T 2207/30268; G06V 40/174; G10L 15/08

(57) ABSTRACT

An aircraft monitoring system includes a data collection module configured to collect a video feed of an aircraft interior. The video feed is directed towards a target, and a recognition module is configured to receive the video feed from the data collection module. The recognition module is configured to recognize the target and an interaction directed towards the target by a user. A decision making component is configured to determine an adjustment to an aircraft component based on the recognized target and interaction thereof.

### CROSS-REFERENCE TO RELATED APPLICATIONS

This application claims the benefit of U.S. Provisional Patent Application No. 63/735,542 filed Dec. 18, 2024, the entire contents thereof are herein incorporated by reference.

### BACKGROUND OF THE INVENTION

### 1. Field

Embodiments of the disclosure relate generally to aircraft monitoring systems and, more specifically, to automated systems that monitor and detect onboard human behavior interacting with aircraft systems and system to system interactions.

### 2. Description of the Related Art

Various solutions have been proposed for automated management systems. For instance, management systems may be implemented on a mobile platform, such as a train, marine vessel, aircraft, or automobile. These systems may include control modules that can move seats or tray tables. The controls can also activate/deactivate light sources and perform combinations thereof based on occupant activity data. Additionally, management systems may control cabin audio systems, passenger and cabin lighting, and in-flight entertainment subsystems.

### SUMMARY

In some embodiments, the techniques described herein relate to an aircraft monitoring system, the system including: a user interface disposed onto an interior aircraft surface; a data collection module including a plurality of imaging components disposed throughout an aircraft and configured to collect input data corresponding to the user interface, the aircraft, or an individual onboard the aircraft; a recognition module configured to receive the input data and recognize an action of the individual directed towards the user interface; a decision-making component configured to determine an adjustment based on the action recognized by the recognition module; and a controller communicatively connected to one or more aircraft components, wherein the controller is configured to receive a command for the adjustment and provide instructions to implement the adjustment to the one or more aircraft components.

In some embodiments, the techniques described herein relate to a system, wherein the data collection module includes a plurality of cameras configured to collect a video feed and an audio component configured to detect and record audio onboard the aircraft.

In some embodiments, the techniques described herein relate to a system, wherein when the input data includes a gesture performed within an aircraft cabin, the recognition module recognizes the gesture and makes a prediction corresponding to the gesture, and the decision-making component determines an adjustment based on the prediction.

In some embodiments, the techniques described herein relate to a system, wherein the gesture is a pressing motion directed to an icon disposed on an aircraft seat and the recognition module predicts the pressing motion is an action directed towards the icon.

In some embodiments, the techniques described herein relate to a system, wherein the input data includes a seat position of the aircraft seat and the decision-making component determines the adjustment based on the pressing motion and the seat position of the aircraft seat.

In some embodiments, the techniques described herein relate to a system, wherein the plurality of cameras are directed towards an icon embroidered onto a surface of an aircraft interior.

In some embodiments, the techniques described herein relate to a method for monitoring an aircraft, the method including: collecting data associated with an aircraft using a data collection module, wherein the data collection module includes a plurality of cameras disposed throughout the aircraft and configured to collect a video feed; recognizing an action of an individual directed towards a user interface, wherein the user interface is disposed on an aircraft interior surface; determining an adjustment based on the action directed towards the user interface, wherein the adjustment corresponds to adjusting an aircraft component; and implementing the adjustment to the aircraft component, the step of implementing including: receiving a command for the adjustment, and providing instructions to implement the adjustment to the aircraft component.

In some embodiments, the techniques described herein relate to a method, including determining the adjustment by identifying the individual onboard the aircraft and referencing a user history associated with the individual.

In some embodiments, the techniques described herein relate to a method, including recognizing a behavior of the individual by detecting a head position, appendage position, posture, expression, or eye position of the individual.

In some embodiments, the techniques described herein relate to a method, including determining an adjustment based on the behavior and the adjustment corresponds to adjusting an aircraft cabin setting.

In some embodiments, the techniques described herein relate to a method, including computing a distance differential between a fingertip of the individual and the user interface.

In some embodiments, the techniques described herein relate to a method, including preloading a threshold distance between the fingertip of the individual and the user interface to determine when the individual directs an action towards the user interface.

In some embodiments, the techniques described herein relate to a method, including recognizing a gesture directed to the user interface when the threshold distance is violated by the fingertip of the user.

In some embodiments, the techniques described herein relate to a method, including: recognizing coordinates of fingertip points on a 2-D plane; generating a depth map using the video feed of the data collection module; and appending depth data points to the fingertip points on the depth map.

In some embodiments, the techniques described herein relate to a method, including: collecting audio and detecting audible words of the individual; recognizing when the audible words correspond to the aircraft component; and determining an adjustment to the aircraft component based on the audible words.

In some embodiments, the techniques described herein relate to a method for aircraft monitoring, the method including: disposing a data collection module throughout an aircraft wherein the data collection module includes a plurality of cameras; disposing a plurality of user interfaces throughout the aircraft, wherein the cameras are configured to monitor the plurality of user interfaces; wherein the plurality of cameras provide a video feed and a recognition module generates a depth map of a region surrounding at least one of the user interfaces, and the depth map provides a distance differential representative of a distance between a body part of an individual onboard the aircraft and the user interface, such that when the distance differential changes an action of the individual directed towards the user interface is detected.

In some embodiments, the techniques described herein relate to a method wherein the data collection module is preloaded with visual tolerance levels to estimate location and position of objects within the depth map.

In some embodiments, the techniques described herein relate to a method wherein the data collection module is preloaded with presets corresponding to unusual objects including gloves, coats, children, or dirt.

In some embodiments, the techniques described herein relate to a method wherein the user interface is disposed on an aircraft seat or an aircraft galley.

In some embodiments, the techniques described herein relate to a method wherein the user interface is a target mimicking a press button, wherein the target is disposed on an aircraft interior surface and change in the distance differential results from a user making a swiping motion towards the target.

### BRIEF DESCRIPTION OF THE SEVERAL VIEWS OF THE DRAWINGS

Illustrative embodiments are described in detail below with reference to the attached drawing figures, which are incorporated by reference herein and wherein:

FIG. 1 illustrates an aircraft monitoring system in accordance with embodiments of the present disclosure;

FIG. 2 illustrates an operational flow chart for the aircraft monitoring system of FIG. 1;

FIG. 3 illustrates an aircraft user seated in an aircraft seat within a camera view of a camera, in an embodiment;

FIG. 4A illustrates one embodiment of a hand model generated using the aircraft monitoring system of FIG. 1;

FIG. 4B illustrates the hand model of FIG. 4A with a side orientation;

FIG. 4C illustrates the hand model of FIG. 4A in another orientation;

FIG. 5 illustrates a process flow chart for creating the hand model of FIG. 4A, in an embodiment;

FIG. 6 illustrates a system for having an adjustable aircraft seat, in an embodiment;

FIG. 7 illustrates an embodiment of a process flow chart for adjusting the aircraft seat of FIG. 6;

FIG. 8 illustrates an automated aircraft management system, in an embodiment;

FIG. 9 illustrates a block diagram of an exemplary computing device, in accordance with embodiments of the present disclosure;

FIG. 10 illustrates an embodiment of a process flow chart for monitoring a position of a cabin component;

FIG. 11 illustrates an embodiment of a process flow chart for monitoring a physiological state of a passenger;

FIG. 12 illustrates an embodiment of an aircraft galley in accordance with embodiments of the present disclosure;

FIG. 13 illustrates an embodiment of an aircraft pathway in accordance with embodiments of the present disclosure;

FIG. 14 illustrates an embodiment of a process flow chart for monitoring a pilot in an aircraft cockpit;

FIG. 15 illustrates an embodiment of a process flow chart for monitoring a pilot in the aircraft cockpit for pilot and aircraft safety;

FIG. 16 illustrates an embodiment of an aircraft cockpit from a top perspective view in accordance with embodiments of the present disclosure;

FIG. 17 illustrates the aircraft cockpit of FIG. 16 from a forward point of view in accordance with embodiments of the present disclosure; and

FIG. 18 illustrates the aircraft cockpit of FIG. 16 from a rearward point of view in accordance with embodiments of the present disclosure.

The drawing figures do not limit the invention to the specific embodiments disclosed and described herein. The drawings are not necessarily to scale, emphasis instead being placed upon clearly illustrating the principles of the invention.

### DETAILED DESCRIPTION

The following detailed description references the accompanying drawings that illustrate specific embodiments in which the disclosure can be practiced. The embodiments are intended to describe aspects of the disclosure in sufficient detail to enable those skilled in the art to practice the disclosure. Other embodiments can be utilized, and changes can be made without departing from the scope of the disclosure. Therefore, the following detailed description is not to be taken in a limiting sense. The scope of the disclosure is defined only by the appended claims and the full scope of the equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc., described in one embodiment may also be included in other embodiments, but is not necessarily included. Thus, the technology can include a variety of combinations and/or integrations of the embodiments described herein.

This disclosure relates generally to automated aircraft monitoring systems and, more specifically, to methods and systems that monitor activities both onboard an aircraft and within its surrounding environment using various sensors, cameras, and audible detection devices. The following description is directed to particular examples for the purpose of describing innovative aspects of this disclosure. However, a person having ordinary skill in the art will readily recognize that the teachings herein can be applied in a multitude of different ways.

### Overview

Embodiments disclosed herein provide systems and a method for having an aircraft monitoring system. In embodiments, a data collection module, decision making component, and controller provide monitoring and control capabilities for a plurality of aircraft systems and components. In embodiments, the data collection module can include imaging components including a plurality of cameras disposed at various locations throughout the aircraft. The imaging components can be configured to monitor targets which can facilitate user interaction and correspond to aircraft systems and components.

Various aspects of the disclosure improve existing technologies, as well as others, by providing methods, components, and systems that support monitoring of aircraft systems and features. Improvements to aircraft monitoring technologies are described in embodiments herein and include using a recognition module and input information to detect user motions, gestures, and behaviors and apply adjustments to aircraft components and systems based upon the input information. Embodiments of the disclosure include a control system configured to receive commands and implement adjustments and provide control for aircraft systems and components using information from the decision-making component communicatively coupled to the camera and audio systems disposed throughout the aircraft.

In some embodiments, the aircraft monitoring system can provide video feeds to monitor and detect individuals aboard an aircraft. For instance, a data collection module may include imaging components such as plurality of cameras or camera network disposed throughout the aircraft and directed towards targets configured to facilitate user interaction with an aircraft system or component. The cameras may be directed towards cabin and cockpit areas and configured to detect an aircraft user onboard the aircraft. In some embodiments, the targets may be an icon or decal or embroidered emblem, and the cameras may detect gestures or motion directed by a user towards a target or gestures performed anywhere in the aircraft cabin. In some embodiments, the data collection module can detect parameters in an external environment of the aircraft when the aircraft is on ground or in flight. In some embodiments, the monitoring system can include an audio system including microphones configured to detect audible phrases and sounds made by users aboard the aircraft.

In some embodiments, a decision making component communicatively connected to the monitoring system is configured to provide recognition of items and/or activities based upon images obtained from the data collection module. For instance, the monitoring system can provide the decision making component with input information collected from cameras, microphones, and sensors disposed throughout the aircraft. In some instances, input information includes video feeds having gesture, motion, and facial patterns which can be used to recognize interaction with targets, identify a user on an aircraft, and to recognize behaviors such as fatigue. In some embodiments, input information can include detections corresponding to a user's behavior or expression and the decision making component can determine adjustments to aircraft systems based on a recognized behavior. In some embodiments, the input information can include data about an aircraft environment, and the decision making component can identify landmarks or features to display on a user interface corresponding to the external environment of the aircraft. In some embodiments, input information can include audible phrases detected by audible detection devices, and the decision-making component can recognize the audible phrase.

In embodiments, a control system is communicatively connected to the decision making component and controls aircraft systems and components. In some embodiments, the control system can control cabin management systems such as lighting, shades, climate control, and seating, which can be set to standard settings or preset to a user-specific settings as determined by the decision making component.

### Example Aircraft Monitoring System

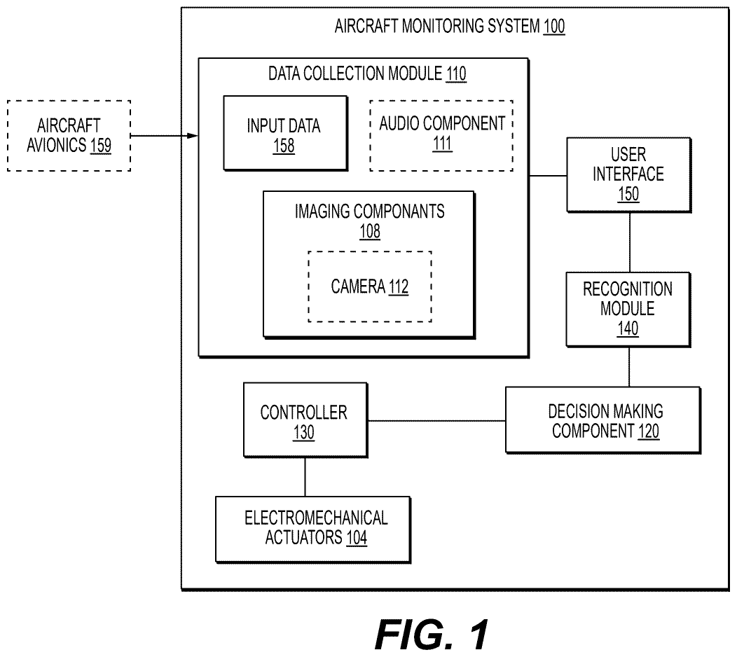

Referring now to FIG. 1, a block diagram of an example aircraft monitoring system 100 suitable for use in implementing embodiments of the disclosure is shown. The aircraft monitoring system 100 is configured to detect an aircraft user and specifically, interactions with components and systems located within an aircraft using a data collection module. Recognition of actions and the determination of adjustments to aircraft systems can be based upon video feeds collected from the data collection module. The aircraft monitoring system 100 can utilize input information including passenger input, in conjunction with recognition techniques, to determine adjustments and implement adjustments with the aircraft using a control system. The aircraft monitoring system 100 is configured to detect the environment onboard the aircraft and collect input information for controlling a variety of components and systems, including a user's interactions and movements with those components and systems.

The aircraft monitoring system 100 includes a data collection module 110, a decision making component 120, a controller 130, a recognition module 140, a user interface 150, and input data 158.

In some embodiments, the data collection module 110 includes a plurality imaging components 108 such as cameras disposed throughout the aircraft and directed towards interior areas or an exterior of the aircraft. More specifically, the cameras of data collection module 110 may include stereo cameras, visible light, and infrared cameras configured to monitor an exterior environment of the aircraft, an aircraft cabin, and cockpit area. In some embodiments, the cameras can be installed into overhead panels, side ledges, floors, interior monument such as seats, and upper and lower sidewalls in the aircraft cabin and cockpit. In some embodiments, data collection module 110 can include an audio component 111 having audio detection devices such as microphones configured to detect audible sounds such as voices.

In some embodiments, the data collection module 110 is configured to detect an individual within proximity of or interacting with a target, which in embodiments, can be user interface 150. The user interface 150, in some embodiments, may include a plurality of targets which can be tracking decals, embroidered emblems, or icons configured to allow users to interact with aircraft systems and components. The user interface 150 may be disposed on aircraft surfaces or component surfaces within camera view of the data collection module 110. In some embodiments, the user interface 150 can be a human machine interface and may be displayed on a screen installed into the aircraft or may be a personal electronic device having a display screen. User interface 150 may allow a user to interact with a variety of aircraft systems and components such as a cabin management system including aircraft seats, cabin lighting, window shades, temperature control, and an aircraft galley. For instance, a target such as a tracking decal may be disposed on an aircraft sidewall and configured to control the lighting within an aircraft cabin. The tracking decal, in some embodiments, may be a mark which is in view of one or more cameras of the data collection module 110 and may lack any physical control components (i.e., a physical button press or mechanical switch).

In embodiments, the data collection module 110 is configured to collect input data 158. The input data 158 can include a video feed from the data collection module 110 which may include user interactions with the user interface 150 and any physical characteristics of the environment within camera view of data collection module 110. In some embodiments, aircraft avionics information 159 may be received by the data collection module 110. In embodiments, the data collection module 110 is configured to detect gestures and motions as well as physical characteristics such as head position, eye position, and orientation of an individual onboard the aircraft as well as remote photoplethysmography (PPG) of the individual. For instance, the data collection module 110 can detect appendages and hands and fingertips of a user and can track user hand motions and gestures. In some embodiments, the data collection module 110 is configured to detect a cockpit area and a pilot and/or co-pilot. More specifically, the data collection module 110 can detect the eye and hand location of a pilot and co-pilot. In some embodiments, the data collection module 110 can detect the external environment of the aircraft both on ground and in flight and/or may receive aircraft avionic information 159 and aircraft flight data. The data collection module 110 can communicate detections as input data 158 which can be transmitted to the decision making component 120 and other systems outside of the aircraft monitoring system 100. In some embodiments, audio component 111 can include audio detection devices to detect audible phrases spoken by users aboard the aircraft. These audible detections can be collected as input data 158.

The decision making component 120 is communicatively connected to the data collection module 110 and is configured to receive the input data 158 which includes the video feed from the data collection module 110 and possibly any audible detections made from audio component 111. The decision making component 120 includes a recognition module 140 which is configured to receive the input data 158 and recognize when an individual is interacting with a user interface 150. In some embodiments, the recognition module 140 can determine a behavior of a passenger in the cabin or a pilot or co-pilot in the cockpit. Exemplary behaviors include but are not limited to awake, asleep, nervous, tired, agitated, etc. In some implementations, the recognition module 140 includes facial recognition technology configured to identify an individuals aboard the aircraft. In some implementations, the recognition module 140 includes a machine learning model configured to recognize hands, fingertips, and target decals or icons. In some embodiments, the recognition module 140 can identify elements in the external environment of the aircraft. For instance, the recognition module 140 may be able to identify air traffic and navigational hazards as well as the location of ground crew personnel.

In embodiments, the decision making component 120 and/or recognition module 140 includes a machine learning component such as a neural network model with neural pathways which perform calculations on the data received from data collection module 110. The neural network model is a brainwork for the decision making component 120 and can identify patterns and make predictions about gestures and motions recorded by data collection module 110 which can be optimized for an identified user or group of users. The neural network may comprise of an input layer, one or more hidden layers of a brainwork capable of having machine learning, and an output layer. For example, the neural network model may use deep learning techniques to learn which combinations of motions, positions or gestures are most likely to indicate an interaction with a user interface 150. To train the neural network model, motions can be recognized and programmed to correspond to directed interactions with a user interface 150 and can serve as a dataset for the neural network model to make computations. The neural network model may be trained using deep learning techniques to train a black box model to recognize gestures, motion, and pose. In some embodiments, other various machine learning algorithms, such as regression or classification, can be used to identify a variety of patterns and motions for user gesture recognition. In some embodiments, the neural network model can be trained in a developmental environment. In some embodiments, late point training may be employed such that the neural network model can detect repeated faults. The decision making component 120 outputs a determination for various features based on the information received from data collection module 110.

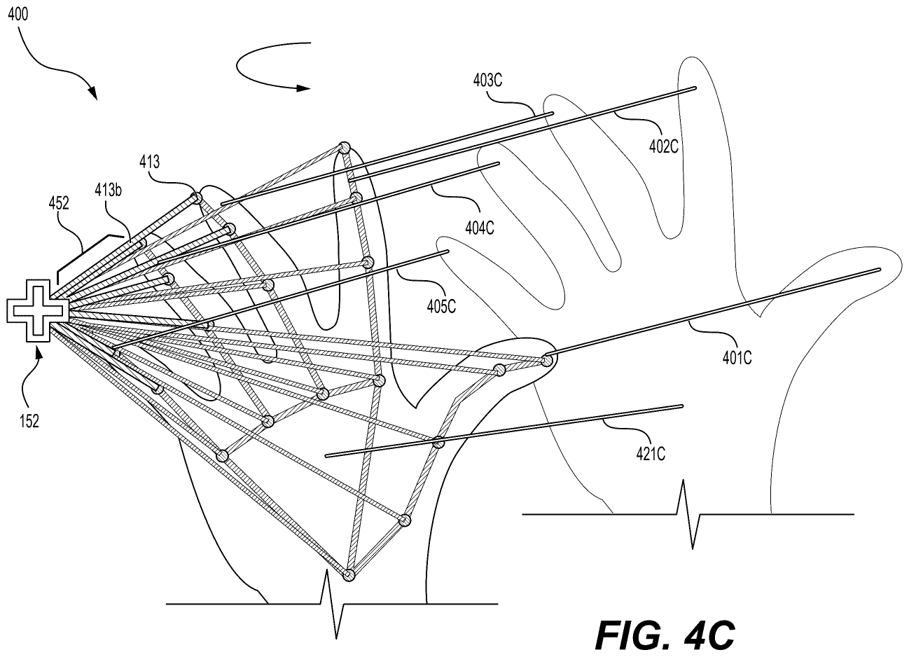

The decision making component 120 is communicatively connected to the controller 130. In some embodiments, the controller 130 may be an IO controller having a processor and memory configured to control aircraft systems and components. In some embodiments, the controller 130 can be configured as part of aircraft avionics or aircraft flight systems. In some embodiments, the decision making component 120 can be communicatively connected to more than one controller, such as controller 620 (see FIG. 6). For instance, the controller 130 may be able to control aircraft cabin components such as seating, lighting, and temperature control. For instance, the data collection module 110 may detect a user and a decal disposed on a sidewall. The recognition module 140 may recognize the user interacting with the decal, which may be a pressing motion in which the user directs a fingertip toward the decal and touches or nearly touches the decal with their fingertip. The decision making component 120 can determine an adjustment based on the recognition of a pressing motion and the decal corresponding to an aircraft lighting system, and the controller 130 receives a command for the adjustment and implements the adjustment and adjusts the cabin lighting.

In some embodiments, controller 130 is a computer, microcontroller, microprocessor, or programmable logic controller (PLC) having a memory, including a non-transitory medium for storing software, and a processor for executing instructions of software. Memory may be used to store information and instructions of software. The software instructions may include but are not limited to algorithms, lookup tables, and computational models. For example, controller 130 may store instructions in memory to accommodate personal preferences of individual users, which may then be reused on subsequent flights or across a fleet of aircraft. Controller 130 may be embodied in one or more printed circuit boards (PCBs) and/or integrated circuits (ICs). Controller 130 is not limited by the materials from which it is formed or the processing mechanisms employed therein and, as such, may be implemented via semiconductor(s) and/or transistors (e.g., electronic integrated circuits (ICs)), etc.

### Method for Monitoring an Aircraft and Individuals Onboard

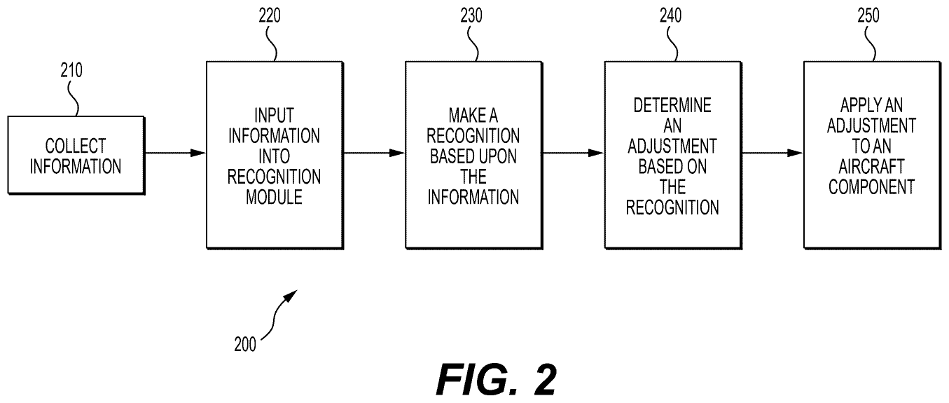

With reference to FIG. 2, a flow diagram is provided illustrating a method 200. Each block of the method 200 and any other methods described herein comprise a computing process performed using any combination of hardware, firmware, and/or software. For instance, in some embodiments, various functions are carried out by a processor executing instructions stored in memory. In some cases, the methods are embodied as computer-usable instructions stored on computer storage media.

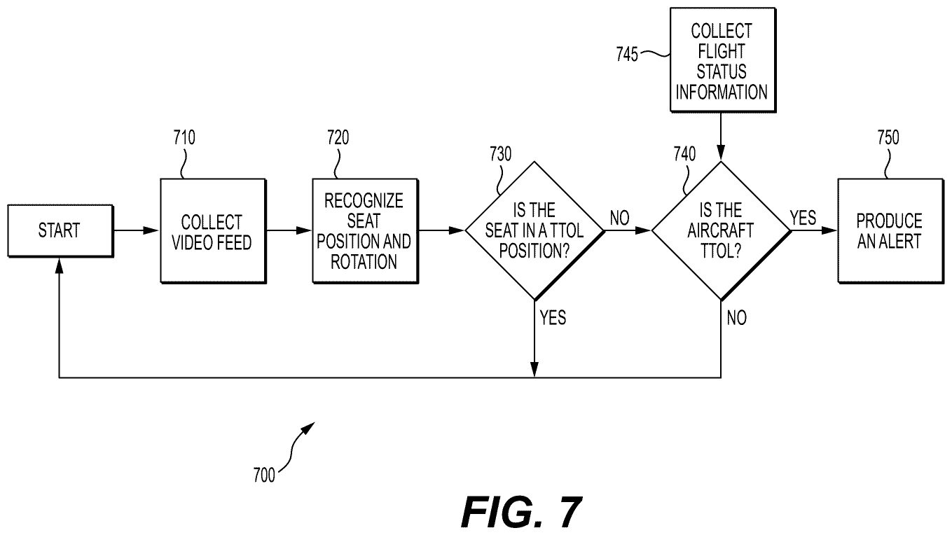

FIG. 2 illustrates a method 200 configured to perform a series of acts for detection onboard an aircraft, in accordance with embodiments of the present disclosure. In one or more embodiments, the method 200 is performed in an environment that includes an aircraft. The environment may include a runway or a hangar, for example. The method 200 may be performed by a computing device such as a computing device 900, described below with reference to FIG. 9. The method 200 is intended to be illustrative of one or more methods in accordance with the present disclosure and is not intended to limit potential embodiments. Alternative embodiments can include additional, fewer, or different steps than those articulated in FIG. 2.

As illustrated in FIG. 2, the method 200 includes a block 210 in which information associated with an aircraft or individuals onboard the aircraft is collected. In some embodiments, the information collected includes a video feed collected from the data collection module 110 of FIG. 1 disposed within/around the aircraft. In embodiments, the data collection module 110 includes a plurality of cameras configured to collect video feeds both internally and externally of the aircraft. For instance, cameras of the data collection module 110 may be disposed within an aircraft cabin environment and directed towards aircraft components such as seats and gallies. In some embodiments, cameras of data collection module 110 may be disposed in an aircraft cockpit and directed towards a control display and pilot seating. In some embodiments, cameras of data collection module 110 may be directed towards an exterior of the aircraft and configured to monitor an aircraft's surroundings both inflight and on-ground as described by U.S. Pat. No. 10,838,068, which is herein incorporated by reference in its entirety. In embodiments, the data collection module 110 may comprise stereo cameras, visible light cameras, and infrared cameras. In some implementations, the cameras of data collection module 110 may be communicatively connected to one another. More specifically, the data collection module 110 may be substantially directed to targets which can be user interface 150 locations, the data collection module 110 configured for the video feed to observe user interactions with the user interface 150. The data collection module 110 may be directed towards aircraft components such as a cockpit control panel, aircraft and cockpit seats, aircraft gallies, and aircraft windows and lighting arrangements.

At block 220, information is input into a recognition module, such as the recognition module 140 of FIG. 1. In an embodiment, information is collected from the data collection module 110 and may include information pertaining to the aircraft and/or individuals onboard or within proximity of the aircraft. For instance, information may include movements or gestures of an individual within camera view of the data collection module 110. More specifically, information may include hand position, head position, appendage position, posture, expression, and eye position of individuals onboard the aircraft. Information may also include seat position, table position, shade state, free object position, visual media content, lighting state, target or decal position, dynamic envelopes, and audio detections. Information may include data associated with an aircraft cabin management system.

At block 230, a recognition based on the information input to the recognition module 140 is computed. In embodiments, the recognition module 140 of decision making component 120 makes a recognition based upon the input information collected using data collection module 110. In embodiments, a recognition may be a user hand motion, hand gesture, arm motion, or another type of movement performed by an individual aboard the aircraft. In some embodiments, a detected audible phrase or word may be recognized and can correspond to an aircraft system. In some embodiments, a hand and target detection machine learning model may identify bounds of targets and the movement and location of a user's fingertips. A recognition may also include an aircraft component, object position, or object movement. For example, the data collection module 110 may be directed towards a target such as a decal disposed on an aircraft seat, an aircraft sidewall, or an aircraft side ledge. In some embodiments the target may be a pattern embossed or embroidered on a surface.

In a specific instance, an individual seated in an aircraft seat or within proximity of the decal may make a gesture to adjust the aircraft seat. A gesture may be a pressing or sliding motion made towards or on the decal. The camera feed, including the gesture/motion of the individual and the position/orientation of the aircraft seat, is communicated to the recognition module 140. The recognition module 140 recognizes the gesture/motion made towards or on the decal on the aircraft seat and the position of the aircraft seat. For instance, the decal disposed on the aircraft seat may correspond to adjusting the orientation and position of the aircraft seat and an individual may make a gesture which is recognized to correspond to adjusting the aircraft seat. When the pressing/sliding motion or gesture is directed to or on the decal, the recognition module 140 recognizes that the individual is making a motion or gesture corresponding to adjusting the aircraft seat.

In some embodiments, the recognition module 140 may be configured to recognize a physical state, such as fatigue, of a pilot or co-pilot. For instance, the data collection module 110 may be configured in the aircraft cockpit and directed towards a pilot and co-pilot piloting the aircraft. The camera provides input to recognition module 140, which in turn provides an indication of a pilot's eyes, head, and hand position. In an embodiment, the recognition module 140 is configured to recognize fatigue of a pilot while operating the aircraft. For instance, based upon the pilot's eye movements and head position, the recognition module 140 can determine the mental state of a pilot such as when a pilot is fatigued or is likely becoming fatigued. For instance, if the recognition module 140 recognizes the eyes of a pilot closing/closed, a slouched posture, or other changes in the pilots physical state, the recognition module 140 may determine that the pilot is fatigued/fatiguing.

In some embodiments, the recognition module 140 may be configured to identify an individual onboard the aircraft. The recognition module 140 can be configured with facial recognition technology to identify an individual or individuals onboard the aircraft. In other embodiments, an individual may interact with a user interface and be identified when a credential or a passcode is entered into the user interface 150. In some embodiments, the recognition module 140 can include voice recognition technology to detect and identify an individual onboard the aircraft based upon their voice.

In some embodiments, the recognition module 140 can recognize a loss of cabin pressure and can determine a mask placement notification should be provided and oxygen masks should be deployed.

At block 240, an adjustment based upon the recognition made at block 230 is determined. In embodiments, the decision making component 120 can determine an adjustment to be made to an aircraft system or component. In some embodiments, the adjustment may be made to an aircraft management system. In some embodiments, adjustments to aircraft systems may be based upon motions/gestures recognized by the recognition module 140. More specifically, in the instance described above, the decision making component 120 may determine an adjustment to the aircraft seat when the recognition module 140 recognizes an individual is making a gesture toward the target corresponding to seat control. The adjustment determined by decision making component 120 may be adjusting the seatback position or direction the aircraft seat is facing, for example.

In some embodiments, the adjustment may be determined based on a recognized physical characteristic of a pilot. For instance, if the recognition module 140 determines the pilot is fatigued, the adjustment may be made to an aircraft component which provides notification to personnel and/or the pilot of possible fatigue being experienced by the pilot. In this way, appropriate measures may be taken by the pilot or other personnel.

In some embodiments, the adjustment may be based upon the recognition module 140 identifying an individual onboard the aircraft. For instance, the adjustment may be user-specific component settings corresponding to a user recognized by the recognition module 140. For instance, a user profile having a user history may be referenced by the decision making component 120 and the adjustments may be determined based upon the information referenced in the user profile.

At block 250, the adjustment determined at block 240 is applied. In embodiments, controller 130 is configured to communicate with aircraft systems and components to receive commands and implement adjustments determined by the decision making component 120 to the aircraft. In embodiments, controller 130 sends commands to the appropriate systems to carry out adjustments. For example, controller 130 receives command signals (e.g., from the decision making component 120, a pilot interface, a user interface 150, or other components, performs calculations and computations based at least partially on the received signals, sends commands to systems, and manages and regulates all functions necessary to carry out an adjustment. For instance, if the decision making component 120 determines an adjustment is needed to the aircraft seat, the controller 130 communicates with mechanisms controlling the aircraft seat to implement the adjustment. More specifically, the controller 130 can control mechanisms configured to control the seat back position and orientation of the aircraft seat. In other embodiments, the controller 130 can implement adjustments to shades, lighting, entertainment, and other aircraft management components and systems.

In some embodiments, the adjustment may be an alert or notification. For instance, if the recognition module 140 recognizes a pilot is fatigued while piloting the aircraft, the decision making component 120 may determine the adjustment is an alert notifying the pilot and/or personnel of pilot fatigue. In some embodiments, the controller 130 can communicate with an alert system to display an alert on a user interface or a cockpit control panel.

### Example Data Collection Module and Environment

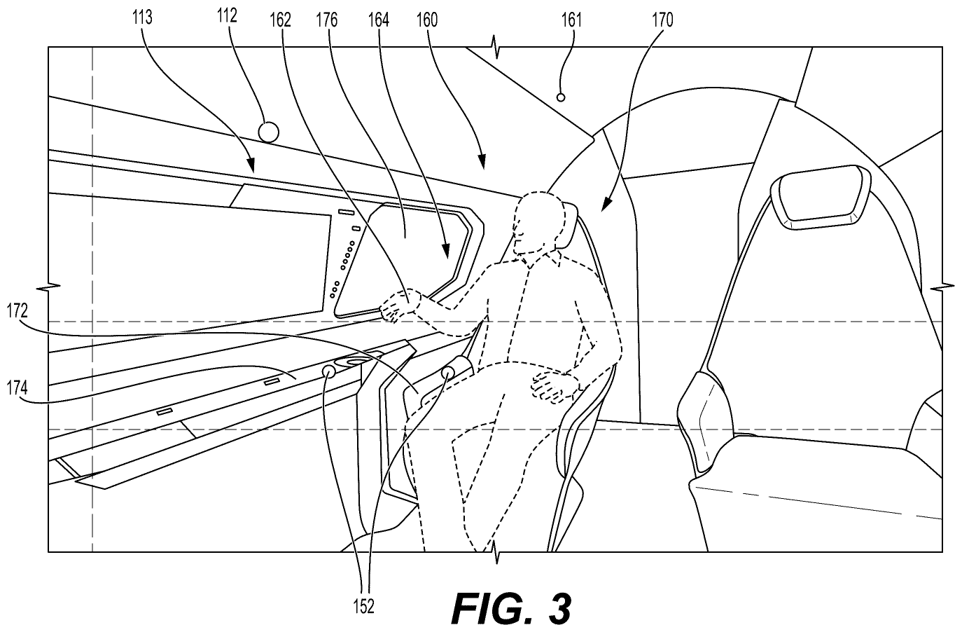

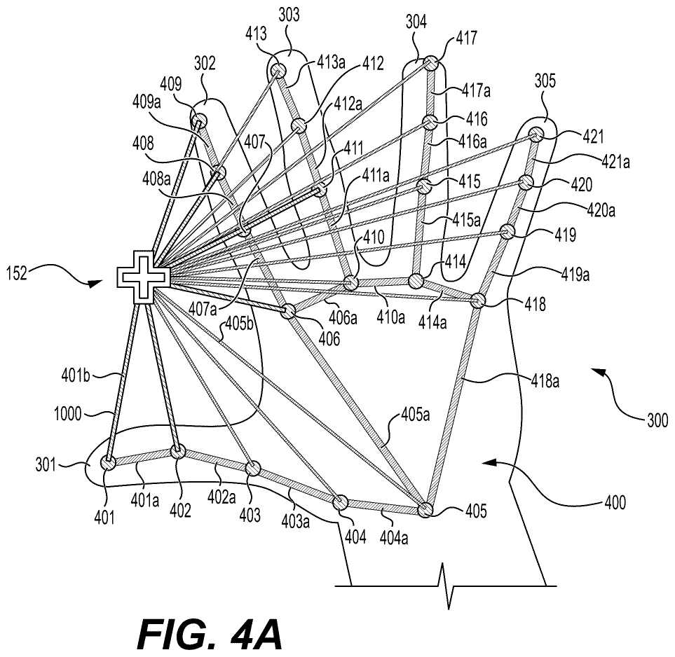

FIG. 3 shows a user 160 seated in an aircraft seat within a camera view of a camera 112 and audible range of an audio component 111, configured as data collection module 110 and audio component 111 of FIG. 1, which includes a user interface 150 and microphone 161. In embodiments, the user interface 150 is configured as a target 152. In the FIG. 3 embodiment, a camera 112 is disposed on an aircraft sidewall with a camera view 113 being directed towards the target 152. The target 152 is located at a defined point in the camera view 113, which can be a cartesian coordinate of other position information stored in recognition module 140. In some embodiments, the target 152 may be a decal, marking, an illuminated marking, or an embossed or embroidered emblem. The target may be raised or recessed and may mimic a physical press button or flip switch. In some embodiments, the recognition module 140 with input data 158 provided from camera 112, may identify a hand 162 and an arm 164 of user 160 by the distinctive shape of the fingers and thumb (hereinafter ‘digits’) of hand 162. The recognition module 140 may identify other distinctive features of hand 162 in other embodiments, such as the knuckles or wrist. In camera view 113, the digits distinguish hand 162 and arm 164 from the aircraft seat 170, armrest 172, aircraft sidewall 174, or other features apparent in camera view 113. The target 152 is disposed on the aircraft sidewall 174 and is within an arm's reach of the user 160 seated in the aircraft seat 170. In embodiments, a hand model may be used in conjunction with data collection module 110 to determine features and movements of hand 162 for detecting intended operations of user interface 150 by user 160. An exemplary hand model 400 is described below in connection with FIGS. 4A-4C. The hand model 400 is described in Nonprovisional patent application Ser. No. 18/421,966 which is incorporated herein.

FIG. 4A shows a user's hand 300 with an overlaid an exemplary hand model 400, along with target 152. The decision making component 120 may use the video feed from camera 112 of data collection module 110 to create hand model 400. As demonstrated in FIG. 2, the recognition module 140 and camera 112 are interfaced via bus and able to transmit electrical signals to one another. The recognition module 140 may comprise an algorithm, machine learning program, or artificial intelligence (AI) program that processes input data 158 from camera 112 to create and thereafter track the position and orientation of hand 300 by repositioning and rearticulating hand model 400. This recognition module 140 may be used to create any number of hand models 400 from a user's hand or hands, such as hand 162 shown in FIG. 3.

In an embodiment, hand model 400 comprises landmarks 401 to 421 such that landmarks 401 to 421 model the shape of a user's hand. Landmarks 401 to 421 represent a user's hand with twenty-one landmarks mapped to digits 301, 302, 303, 304, and 305 of the user's hand. In an embodiment, each landmark is a vertex that comprises a geometric model of the hand wherein the vertices are connected to create the shape of fingers, a thumb, and a wrist. Digit 301 is represented by landmarks 401, 402, 403, 404, and 405, which represent the user's thumb. Digit 302 is represented by landmarks 406, 407, 408, and 409, which represent the user's index finger. Digit 303 is represented by landmarks 410, 411, 412, and 413, which represent the user's middle finger. Digit 304 is represented by landmarks 414, 415, 416, and 417, which represent the user's ring finger. Digit 305 is represented by landmarks 418, 419, 420, and 421, which represent the user's pinky finger. Alternate embodiments may place any number of landmarks at any point on a user's hand 300 to create a hand model 400; other distinct hand features such as the palm, wrist, or knuckles may be tracked to create hand model 400 in other embodiments.

In hand model 400, landmarks 401 to 421 are connected to each other via connections 401a to 421a. In an embodiment, the lines drawn by connections 401a to 421a represent the user's digits or other features representative of the shape of a user's hand. An embodiment arrangement of these connections is as follows: connections 401a, 402a, 403a, and 404a model the thumb on the user's hand. Connections 405a, 407a, 408a, and 409a model the index finger and part of the palm on the user's hand. Connections 411a, 412a, and 413a model the middle finger on the user's hand. Connections 414a, 415a, and 416a model the ring finger on the user's hand. Connections 418a, 419a, 420a, and 421a model the pinky finger and part of the palm on the user's hand. Connections 406a, 410a. and 414a model part of the palm on the user's hand.

Additionally, each of the landmarks 401 to 421 has a distance vector 401b through 421b drawn to target 152. Using a video feed captured by camera 112, the recognition module 140 may also compute a plurality of trajectory vectors 401c through 421c for landmarks 401 through 421 wherein trajectory vectors 401c through 421c describe the expected movement of landmarks 401 through 421 in future frames of the video feed recorded by camera 112.

Information about each of landmarks 401 to 421 is stored within an array, list, or data structure, and data for all landmarks 401 to 421 are stored together in a matrix. In an embodiment, landmark tracking is accomplished by assigning each of landmarks 401 to 421 a numerical value in four data fields: a hand ID, a landmark ID, an x-position, and a-y position. These data are stored in a list by the safety program. Together, these data distinguish each landmark. The hand ID is used to identify the hand that a given landmark is a part of. For instance, a user's left hand may be assigned hand ID “1”, and the user's right hand may be given a hand ID “2”. The landmark ID identifies a specific landmark within a hand. For instance, given 21 landmarks per hand, each landmark would be given an integer identifier 0 through 20 or 1 to 21 to distinguish the landmarks on a particular hand. The x-position and γ-position provide the positions of each landmark within view of the camera. The x-position and γ-position of a landmark are used to calculate a distance from that landmark to target 152. Target 152 is a point in camera view 113 of camera 112. In an embodiment, a user determines the position of target 152 as seen in camera view 113 of camera 112. For instance, the control system 130 may be interfaced to a set of IO controls available to a user, which can be the target 152 of user interface 150 as shown in FIG. 3. Using decision making component 120, a user may be able to assign the target 152 to a location in the aircraft cabin accessible by a user either seated in or standing in vicinity of aircraft seat 170 as seen in camera view 113 of camera 112. For instance, the target 152 may be at an intuitive location for a user to control a window shade 176 or aircraft lighting.

Hand model 400 is demonstrated in an alternate position and orientation in FIG. 4B. A sample landmark 413 with distance vector 413b is identified on digit 303 to clarify how recognition module 140 tracks and adjusts hand model 400 as the position and orientation of hand 300 changes. As a user moves their hand 300 in view of camera 112, the safety program may track hand 300 and continuously superimpose hand model 400 over hand 300. Thus, the recognition module 140 dynamically tracks hand 300 as hand 300 assumes a variety of positions and orientations while in view of camera 112. Thus, the positions of landmarks 401 through 421 move such that they remain superimposed on hand 300 as hand 300 moves.

FIG. 4C demonstrates another position and orientation of hand 300 with hand model 400 superimposed over hand 300. To demonstrate the dynamic tracking, note that distance vector 413b shown in FIG. 4B is denoted a first distance 450 away from target 152 while the same distance vector 413b shown in FIG. 4C is denoted a second distance 452 away from target 152. The recognition module 140 monitors the distance vectors 401b to 421b and the trajectory vectors 401c to 421c when a user interacts with the target 152. The recognition module 140 may have access to a numerical value or values of interactive and non-interactive distances for any landmarks 401 to 421 to be at relative to target 152 and will compare these values to the values of distance vectors 401b through 421b. The recognition module 140 may represent vectors 401b through 421b as first distance 450 or a second distance 452, while the recognition module 140 can determine the distance between the target 152 and first and second distances 450 and 452. As the recognition module 140 monitors trajectory vectors 401c through 421c of landmarks 401 to 421 (only vectors 401c-405c and 412c are shown in FIG. 4C for clarity), it may determine that any landmark 401 to 421 may be about to interact/contact (i.e. an interactive distance) target 152, or that a landmark 401 to 421 remains and/or will remain a non-interactive distance away from target 152.

Second distance 452 is a radius or line segment with one vertex on target 152. Second distance 452 may be arbitrarily assigned, assigned by a user, or calculated by the recognition module 140. The recognition module 140 may use a top speed of a user's hands (pre-assigned or otherwise determined) to compute the first or second distance 450 or 452. The recognition module 140 may measure the distances 450 and 452, connections 401a to 421a, distance vectors 401b to 421b, and trajectory vectors 401c to 421c in units of pixels to streamline the usage of video feed of camera 112.

### Method for Detecting a User Interaction

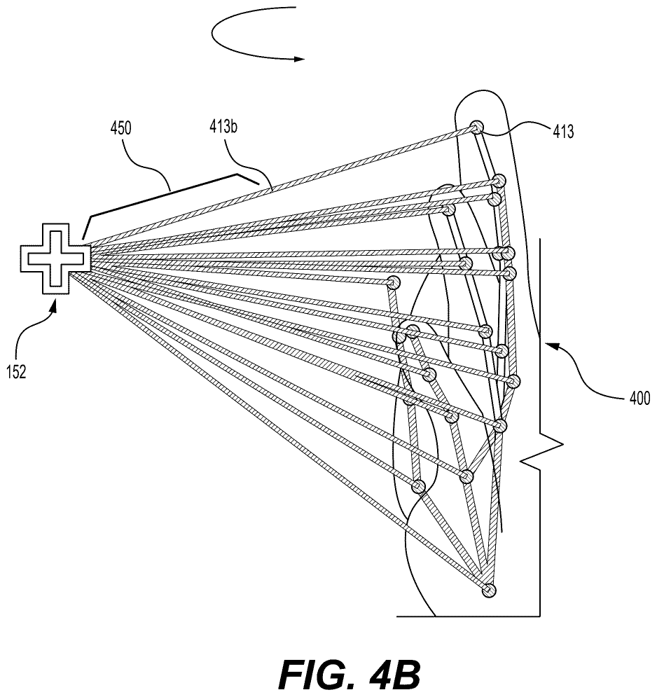

FIG. 5 shows a method 500 wherein the monitoring system 100 is powered on. In some embodiments, the monitoring system 100 may be powered on when the aircraft and the aircraft auxiliary power unit is powered on. A camera 112 coupled to decision making component 120 can be directed towards a target 152.

At block 510, a video feed is collected. In embodiments, the video feed may be collected using the data collection module 110. In some embodiments, a depth map of the region within camera view is generated using the video feeds from data collection module 110. In embodiments, the video feed may be collected in real-time or near-real-time and can be stored in the decision making component 120

At block 520, information is input to decision making component 120. In embodiments, information includes the video feed captured using the data collection module 110 and can include information such as infrared detections made using infrared cameras disposed within the aircraft. Information can also include data about an aircraft state of flight and whether or not the aircraft is in a taxi, takeoff, or landing (TTOL) phase of flight.

At block 530, the recognition module 140 processes the video feed from camera 112 to locate an object in the scene. The object may resemble a “hand-ish” object which may be a user's hand, such as hand 162 shown in FIG. 3. Optionally, a user may be expected or prompted to display their hands in camera view 113.

At block 532, if a “hand-ish” object is located, the decision making component 120 and recognition module 140 can establish a hand model in step 532a. This hand model may be hand model 400 with landmarks 401 to 421 and landmark connections 401a to 421a as shown in FIG. 4A. In some embodiments, the recognition module 140 can recognize and detect fingertips and fingertip locations. In embodiments, the camera 112 detects the hand 162 within the camera view 113. In some embodiments, the recognition module 140 may be equipped with a hand detection machine learning model. The recognition module 140 may be able to list 2-D coordinates of fingertip points and append depth data points to the fingertip locations using a generated depth map. If a “hand-ish” object is not located at block 532, the method 500 proceeds to block 540.

At block 540, a target is located. In embodiments, decision making component 120 is configured to locate a target which may be decal 152 in camera view 113 of camera 112. Target 152 in camera view 113 of camera 112 may be automatically identified by decision making component 120, or otherwise be manually assigned to the recognition module 140. In some embodiments, the recognition module 140 may include a button target detection machine learning model. In some embodiments, the target can be embossed or embroidered and may be an illuminated icon or a display enabling selection of control settings for a variety of objects or aircraft systems. In some embodiments, decision making component 120 is configured to located bounds of the target region and append depth data to the target region location. In some embodiments, the decision making component 120 is configured to set thresholds and presets for object detection model execution. In embodiments, a preset can correspond to visual tolerance levels for estimating the location and position of objects within the camera 112 range. Presets can be particularly useful in scenarios involving human interaction with a visual target, as they accommodate variations in individual forms and gesture approaches, which can differ significantly from one person to another. In some embodiments, the thresholds and presets can be objects or items outside of expected conditions such as gloves, coats, children, or dirt. These presets and thresholds can improve efficiency by providing additional information to the decision making component 120 prior to detecting an interaction.

At block 550, an interaction with the target may be detected. In embodiments, the recognition module 140 is configured to recognize gestures and/or hand motions which may indicate the user is interacting with target 152. In embodiments, hand motions or gestures recognized by recognition module 140 may be pressing motions which may be recognized when a user presses the target 152 with any of digits 301-305 as shown in FIG. 4A. Other motions, which may be sliding motions, when a user slides one of digits 301-305 upwards, downwards, left, or right proximate the target 152 can also be recognized by recognition module 140. In some embodiments, the recognition module 140 can compute a distance differential between fingertips of a user's hand and the target region location. In some embodiments, the recognition module 140 may be preloaded with a threshold distance to determine when a user engages in a pressing motion with a target. In some embodiments, the detection may be a hand motion with a decal corresponding to a request for an audible input. In this case, the audio component 111 can use microphone 161 to detect a voice of an individual and the recognition module 140 can recognize words or phrases corresponding to an aircraft component.

At block 560, an adjustment to an aircraft system or component is determined. In embodiments, decision making component 120 is configured to determine an adjustment based upon the recognition made by recognition module 140. For instance, an adjustment may be adjusting a window shade, window tint, cabin lighting, an aircraft seat position or orientation, an entertainment system, or cabin temperature setting. For instance, if the recognition module 140 recognizes a user presses a target or decal corresponding to a setting, the decision making component 120 can determine an adjustment to implement to the aircraft or component.

At block 570, the adjustment is implemented to the aircraft. In embodiments, the controller 130 can receive a command and make an adjustment determined by decision making component 120 based upon the motion detected by the camera 112 and recognized by the decision making component 120. In embodiments, the controller 130 is connected to auxiliary aircraft components and systems and can make adjustments determined by the decision making component 120. For instance, an adjustment may be to adjust lighting in the aircraft cabin. In embodiments, if a pressing motion is detected by the camera 112 and recognized by the recognition module 140, the decision making component 120 may determine that an individual is powering on or off a cabin lighting fixture and can communicate with the controller 130 to power on or off the cabin lighting fixture. In some embodiments, a target or decal may correspond to the window tint and shade control, and a user pressing the decal corresponding to a window shade can trigger an adjustment to the window shade, or a user pressing the decal correspond to window tint can trigger an adjustment to the window tint.

In some embodiments, aspects of the method 500 can be applied to a user interface having a display screen. For instance, the data collection module 110 can collect video feeds used by the recognition module 140 to generate a depth map of the cabin and locate user fingertips using a hand detection machine learning model. The data collection module 110 can locate objects displayed on a user interface having a display screen. Displayed objects on the user interface may be exterior landmarks, icons, or other markings which can correspond to components or aircraft systems. For instance, a machine learning model may be able to determine items of interest to display on the user interface display screen. In some embodiments, using the collected video feeds from data collection module 110, the recognition module 140 can detect edges of the display screen and distort images to a standard form factor. From the distorted images the recognition module 140 can locate items of interest displayed on the display screen.

In some embodiments, items of interest displayed on the user interface display screen may be landmarks and geographical locations passing by the aircraft during flight. Aircraft flight information, such as altitude, local time, and airspeed may also be displayed on the user interface. In some embodiments, items of interest may be icons corresponding to entertainment settings controlling visual and audio settings. In some embodiments, items of interest may be call buttons configured to provide notification to a pilot, or other personnel.

The recognition module 140 recognizes when a user interacts with user interface 150, which can be an item of interest on the display screen. In embodiments, the recognition module 140 may recognize a gesture which indicates interaction with the user interface 150. In some embodiments, an interaction may be a pressing or sliding motion directed towards the item of interest. An adjustment can be determined by the decision making component 120 and implemented by the controller 130. For instance, in a particular case, an adjustment may be displaying additional information about a landmark or geographical location. In some embodiments, the landmark or geographical location can be locally distorted based upon tracked user eye detections to enhance the visual perception of the user. In another case, an adjustment may be adjusting an audio or visual entertainment setting. In yet another case, an adjustment may be providing a notification to a pilot or aircraft personnel.

### Example Aircraft Seat Adjustment System

FIG. 6 shows a block diagram of an example control architecture 615 used for a seat control system. In embodiments, controller 620 actively monitors subsystems of the seat 600, receives actions to be performed from decision making component 120, and then sends commands to the appropriate seat subsystems. For example, controller 620 receives signals (e.g., from the decision making component 120, a pilot interface, a user interface 150, or other seat subsystems), performs calculations and computations based at least partially on the received signals, sends commands to seat subsystems, and manages and regulates all functions necessary for operation of seat 600. Additionally, controller 620 manages signal input/output (I/O) as well as power and communication links for controlling functionality of seat 600. In certain embodiments, controller 620 is a local controller dedicated to a particular seat 600 such that an aircraft having a plurality of seats 600 also have a respective plurality of local controllers 620. In some embodiments, controller 620 is located within seat 600 such that when a seat 600 is installed on an aircraft, seat 600 includes a built-in controller 620. The controller 620 or each of controllers 620 is communicatively coupled to the decision making component 120.

Controller 620 is for example a computer, microcontroller, microprocessor, or programmable logic controller (PLC) having a memory 622, including a non-transitory medium for storing software 640, and a processor 621 for executing instructions of software 640. Memory 622 may be used to store information and instructions of software 640, such as instructions 641-649 listed in FIG. 6 and described below. The software instructions may include but are not limited to algorithms, lookup tables, and computational models. For example, controller 620 may store instructions in memory 622 for customizing seat configurations to accommodate personal preferences of individual users, which may then be reused on subsequent flights or may be stored remotely so that a fleet of aircraft may reference the stored personal preferences. Controller 620 may be embodied in one or more printed circuit boards (PCBs) and/or integrated circuits (ICs). Controller 620 is not limited by the materials from which it is formed or the processing mechanisms employed therein and, as such, may be implemented via semiconductor(s) and/or transistors (e.g., electronic integrated circuits (ICs)), etc.

Controller 620, in embodiments, communicates with user interface 150 for a user to receive information and input instructions for adjusting seat 600. In certain embodiments, user interface 150 may be target 152 or a decal embossed or embroidered into the seat armrest with indicia intuitive for enabling a user to manipulate movement of the seat, as well as access to seat temperature control and cabin management systems. In some embodiments, a user seated in seat 600 may make motions or gestures within the camera view of cameras 112 for the recognition module 140 and decision making component 120 to recognize the user is attempting to adjust the seat and determine movements of the seat desired by the user. The user may be an occupant of seat 600 (e.g., a passenger or crew member), maintenance personnel, or other aircraft operator/manager. In some embodiments, a crew interface 639 is optionally provided for enabling a crew member (e.g., a pilot or attendant) to control functions of seat 600.

Communication between controller 620 and subsystems of seat 600, which are described below, may be by one of a wired and/or wireless communication media. For example, controller 620 includes input/output (I/O) ports for communicating with various subsystems of seat 600. Industry standard safety protocols are used to ensure that all wireless signals avoid having radio frequency (RF) energy couple onto aircraft system critical lines. A wireless gateway 609 may optionally be employed for facilitating wireless communication as further described below.

Controller 620 is adapted to manage all communication between the subsystems, including features which are both internal and external to controller 620. Communication with external subsystems may be one-way or bidirectional. For example, the cabin management system (CMS) 670 communicates bidirectionally with controller 620 (e.g., CMS 670 transmits data to controller 620 and controller 620 transmits data to CMS 670), whereas accelerometers 608 transmit data to controller 620 but typically do not receive data from controller 620. Massage feature 657 receives data commands from controller 620 but typically does not transmit data to controller 620.

Internal communications may occur between various features performed by controller 620. For example, pressure map instructions 641 process data received from pressure sensor array 610 to determine whether a user is experiencing an uncomfortable position. As a result, controller 620 may transmit command signals to massage feature 657 for activation. In certain embodiments, massage feature 657 may be activated when the decision making component 120 using information from data collection module 110 recognizes a user interacting with user interface 150 independent of pressure mapping information.

A hexapod seat base 680 uses linear actuators to provide movement for seat 600. Controller 620 can provide commands to each of the actuators via seat base instructions 643 or power management instructions 642. Controller 620 may also provide active commands to actuators via vibration-control instructions 644 for providing active vibration damping based on information received from accelerometers 608. Controller 620 may also provide active commands such as rib bolster instructions 647 and massage control functions 648

Portions of seat 600 may be heated or cooled using a heating/cooling system. Controller 620, using temperature control instructions 645, processes heating and cooling requests from a user (e.g., via user interface 150). In response to the requests, controller 620 turns on various components of the heating/cooling system. Controller 620 also monitors predetermined threshold temperatures to prevent system and component damage as well as occupant injury.

Portions of seat 600 may be moved via position motors under control of controller 620. Exemplary portions of seat 600 that may be electrically deployed via position motors include a footrest, a headrest, armrests, the height of the seatback and an angle of the seatback (e.g., for reclining). Controller 620 processes deployment and retraction requests (e.g., received from decision making component 120) and monitors a dynamic operational envelope to ensure the requests do not present interferences based on data received from a network of proximity and position sensors 658, which are further described below. In some embodiments, the data may be received from the data collection module 110 and directed to monitor the position and orientation of the seat 600. Using seat articulation instructions 646, controller 620 can send commands to position motors disposed within seat 600 for adjusting various features of the seat. These include a seatback height 651, a seatback angle 652, a headrest position 653, a footrest position 654, armrest positions 655, and rib bolster positions 656. In certain embodiments, headrest 653 includes audio features such as noise cancellation and/or personal audio speakers under control of controller 620.

The position, direction, and orientation of seat 600 is recognized and determined using the data collection module 110. In embodiments, the camera feed collected using data collection module 110 allows the recognition module 140 and decision making component 120 to recognize and determine the position and orientation of the seat 600 and determine proximity of seat 600 to nearby components of the aircraft. Controller 620, using operational envelope instructions 649, continuously determines and maintains a safe positional envelope for movement of seat 600. Signals from the decision making component 120 are received by controller 620 and processed to determine locations of obstructions, both fixed and dynamic, and to determine that any seat movement commanded by the user will not result in a collision between the seat and another object, the user, or another passenger.

Controller 620 receives inputs from a user via the decision making component 120. The decision making component 120 recognizes interactions with user interface 150 which enables the user to command movements and features of seat 600. In certain embodiments, user interface 150 is a target 152 which is a target monitored by the camera 112. In some embodiments, the user interface 150 can include a joystick such that the camera 112 can monitor the position and movement of the joystick and the decision making component 120 can determine adjustments for the controller 620 to implement to the seat. User interface 150 is integrated into seat 600 as shown in FIG. 3.

Wireless connectivity provides bidirectional wireless communication between controller 620 and subsystems of seat 600, as well as other aircraft systems. In certain embodiments, a wireless gateway 609 provides digital I/O connection between the seat, the aircraft and user. Wireless gateway 609 may be a router or integrated access device (IAD) that contains a plurality of I/O interfaces in order to wirelessly connect with controller 620 and subsystems of seat 600. Wireless gateway 609 reduces physical connections between the electric seat and the aircraft and may be adapted to provide a higher data throughput. The wireless communication may include, but is not limited to, WiFi, Bluetooth, ad-hoc mesh networking, long range (LoRa), and long range wide area network (LoRaWan) and/or LiFi. With wireless connectivity, features of seat 600 may be controlled by the user via a personal electronic device that is communicatively coupled with wireless gateway 609. In some embodiments, wireless gateway 609 may include a web service application programing interface (API) client for handling Internet communication such that the user may control features of seat 600 via a personal electronic device while not onboard the aircraft. For example, the user may activate the heating/cooling system to precondition (e.g., preheat or precool) their seat while travelling to the airport.

The cabin management system (CMS) 670 provides control of features on the seat to the flight crew. CMS 670 provides ship-side information to controller 620 for processing and management, which may include, but is not limited to, TTOL configuration, thermal control of the seat, automatic bed configuration, lockout feature (e.g., for infant/child protection), and a wake-up feature that uses a subtle vibration from hexapod seat base 680 to gently wake the occupant. Controller 620 provides feedback to CMS 670 for features not local to the seat, such as lighting, attendant call, cabin temperature control, audio and video selection, etc.

In certain embodiments, the aircraft management system 670 has the ability to configure a plurality of seats 600 into the TTOL position using recognitions from the recognition module 140. For instance, if the data collection module 110 detects the aircraft is ascending or descending, the decision making component 120 can determine adjustments for seats 600 to be in a TTOL position and the controller 620 can implement the adjustments to the seat or seats 600. In some embodiments, possibly during emergency cases, a pressing motion or gesture directed towards a target 152 can be detected by data collection module 110 and recognized by recognition module 140 for adjustments to be implemented by the controller 620 and return the seat 600 to a TTOL position. In embodiments, the target 152 or decal may be positioned on the seat 600 and/or in a cockpit or cabin area.

### Method for Detecting an Aircraft Seat Configuration

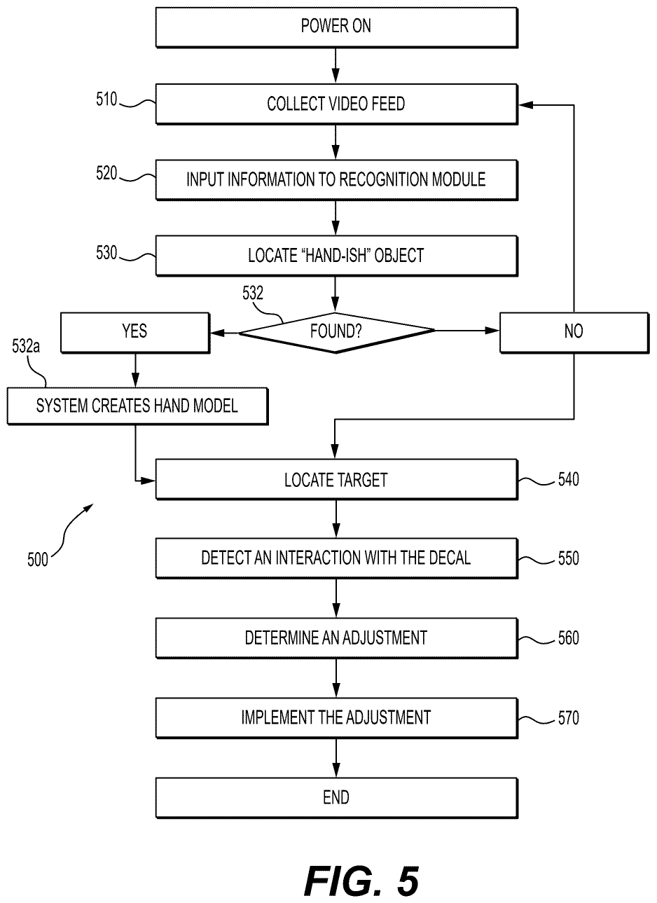

FIG. 7 shows a method 700 wherein the monitoring system 100 is powered on. In some embodiments, the monitoring system 100 may be powered on when the aircraft or the aircraft auxiliary power unit is powered on. In embodiments, the data collection module 110 is directed towards an aircraft seat or a plurality of aircraft seats configured in the aircraft cabin.

At block 710, cameras disposed in the aircraft cabin collect a video feed of objects in the aircraft cabin. In embodiments, the imaging components 108 may be directed towards an aircraft seat or seats 600.

At block 720, the seat position and rotation are recognized. In embodiments, using the camera feeds from the data collection module 110 the recognition module 140 can recognize a seat position and orientation relative to stationary or static cabin components that are not configured to rotate, which may be walls, side ledges, or windows. In embodiments, the recognition module 140 is configured to utilize object contours to determine a rotational baseline for the aircraft seat. The recognition module 140 can determine an amount of seat rotation relative to the baseline position of static objects as well as contours of the aircraft seat. The contours of the aircraft seat, as seen in the video feed, change when the seat is rotated to various degrees and allow the recognition module 140 to recognize the degree the aircraft seat is rotated. In embodiments, the recognition module 140 recognizes the position of the seat, which may be if the seat is tracked to a fully forward or aft position.

At block 730, the aircraft monitoring system 100 determines if the aircraft seat is in a taxi-takeoff and landing (TTOL) position. In some embodiments, the TTOL position is determined by whether or not the aircraft seat violates a rotational threshold, i.e., is angled away from a forward-facing orientation. If the aircraft seat is in a TTOL position the method 700 loops back to the start, and if the aircraft seat is not in a TTOL position the method 700 advances to block 740.

At block 745, flight status information is collected. In embodiments, the aircraft monitoring system 100 can communicate with aircraft sensors and flight interfaces to collect flight information such as the aircraft phase of flight (i.e., takeoff, cruising, or landing) and any current or expected turbulent flight. In some embodiments, data collection module 110 may be directed towards an aircraft exterior and configured to detect the aircraft phase of flight.

At block 740, the aircraft monitoring system 100 determines if the aircraft is in a TTOL phase of flight. The flight information received from block 745 can provide information such as aircraft speed and pitch such that the aircraft monitoring system 100 can determine if the aircraft is taxiing, taking off, or landing. If the aircraft is not in a TTOL phase of flight, the method 700 loops back to the start, and if the aircraft is in a TTOL phase of flight, the method 700 proceeds to block 750.

At block 750, an alert is produced which provides notification that the aircraft seat is not in a TTOL position while the aircraft is in a TTOL state of flight. In embodiments, the alert may notify pilots, passengers, and aircraft personnel and can be displayed on a user interface 150. A notification can alert passengers seated in the aircraft seats to return the seats to a TTOL position when the aircraft is in a TTOL phase of flight.

### Example Aircraft Management System

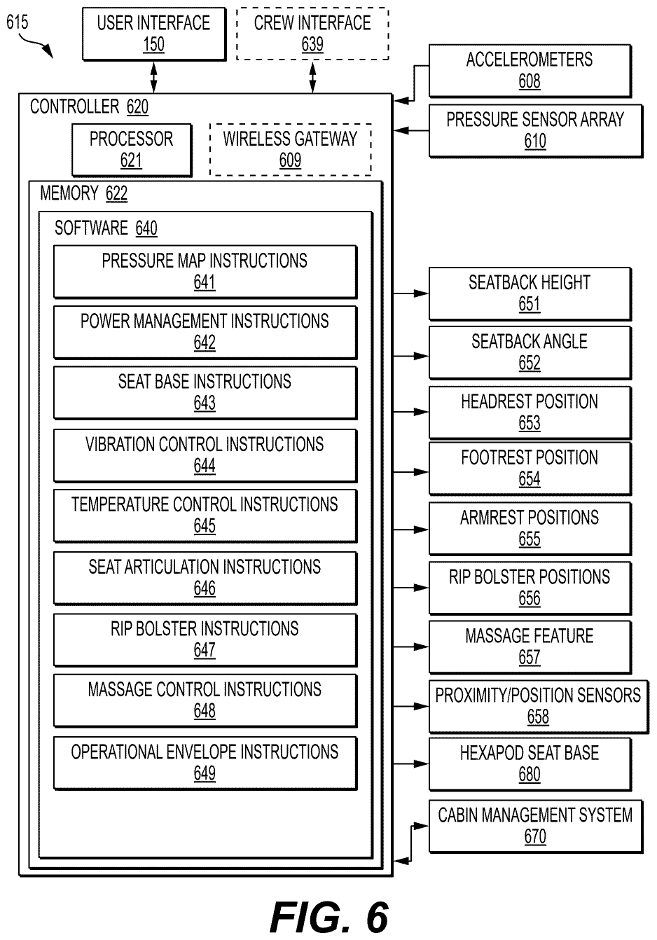

Referring now to FIG. 8, a block diagram of an example automated aircraft management system 800 suitable for use in implementing embodiments of the disclosure is shown. The automated aircraft management system 800 is configured to predict passenger interaction with components and systems located within an aircraft using various sensors, such as the aircraft monitoring system 100, as well as predict anomalies that may occur to components associated with the aircraft. The automated aircraft management system 800 can utilize sensor data and video feeds (i.e., data collection module 110), historical data, and passenger input, in conjunction with machine learning techniques, to predict settings and/or anomalies associated with the aircraft and provide those predictions within an aircraft analysis. Using the aircraft analysis, the automated aircraft management system 800 can implement changes to the settings and take corrective actions to address potential anomalies occurring to the aircraft.

The automated aircraft management system 800 includes an input module 810, a machine learning component 820, an aircraft analysis 830, an adjustment component 840, storage 850, and an alert mechanism 860. In embodiments, the automated aircraft management system 800 acts in an environment onboard an aircraft.

In some embodiments, input module 810 includes collected data from sensors which can include the data collection module 110 to provide the machine learning component 820 with information about a cabin environment, such as temperature, humidity, and lighting. Input module 810 may include user inputs received by an individual to adjust mechanisms in the aircraft (i.e., the data collection module 110 may detect a user interacting with a target 152). For instance, a user input may be a command (i.e., a gesture, motion, or audible cue) to adjust a mechanism controlling cabin temperature or lighting. Input module 810 may include motions and gestures corresponding to an activity. For example, an activity detected by sensors may be a user interacting with a target 152 corresponding with an aircraft galley or aircraft seat adjustment. Input module 810 may include sensor readings corresponding to aircraft diagnostics including an air supply, electrical, or mechanical system. A sensor reading may be indicative of maintenance required on the aircraft.

The machine learning component 820 is a component of the automated aircraft management system 800 configured to identify patterns and make predictions about desirable cabin environment settings, maintenance, predictive diagnostics, and usage data, each of which may be optimized for an identified user or group of users. For example, the machine learning component 820 may use machine learning algorithms to learn which combinations of temperature, humidity, and lighting levels are most likely to create a comfortable and relaxing atmosphere for passengers (e.g., for passengers in general and for specific individual passengers). In some embodiments, the machine learning component 820 includes facial recognition technology such that individuals onboard the aircraft may be identified and user-specific cabin settings can be implemented.

In embodiments, machine learning component 820 calculates an aircraft analysis 852 which identifies adjustments able to be made to aircraft systems. In some embodiments, aircraft analysis 852 is based on input module 810. In some embodiments, the aircraft analysis 852 can include using adjustment component 840 to make adjustments to aircraft systems, detecting anomalies or conditions, and adding data to user profile 854.

The aircraft analysis evaluator 830 is a component of the automated aircraft management system 800 configured to analyze the aircraft analysis 852 and provide recommended adjustments and corrective actions based on the analysis. The aircraft analysis evaluator 830 may provide adjustments which may be used by adjustment component 840 aircraft settings in real-time.

The adjustment component 840 is a component of the automated aircraft management system 800 configured to adjust mechanisms, which can include adjusting thermostats, lighting mechanisms, and other controlling mechanisms to adjust aircraft systems.

In embodiments, storage 850 includes stored data, which may include stored aircraft analysis 852 and user profiles 854. In some embodiments, storage 850 includes historical data specific to individual users to provide customization to aircraft components and environments. For instance, user profile 854 can include user cabin temperature and lighting preferences and user activities in the aircraft and with aircraft components.

The storage 850, including stored aircraft analysis 852 and user profile 854, can provide historical data, including passenger behavior and cabin environment settings detected by the sensors to create a dataset for machine learning component 820 to make computations.

In embodiments, alert mechanism 860 is configured to alert aircraft personnel. For instance, the alert may include notifying personnel of a predicted system failure or a task that may need to be attended to. For instance, as described above, machine learning component 820 may compute an anomaly or condition that requires attention, and the alert mechanism 860 notifies personnel of the condition or anomaly associated with aircraft analysis 830. For instance, a video feed input by input module 810 into machine learning component 820 may be associated by aircraft analysis 830 as being indicative of a faulty aircraft system. More specifically, the video feed may be directed towards a lighting system, in which the machine learning component 820 could recognize an anomaly such as a faulty light bulb in the aircraft. The alert mechanism 860 can implement a corrective action notifying personnel to replace the faulty light bulb. In some embodiments, the machine learning component 820 could recognize an aircraft seat is not in the TTOL position, and the aircraft is in a TTOL phase of flight, which could be a safety concern. An alert notifying personnel of the aircraft seat could notify personnel and/or a seat user to adjust the seat.

### Method for Monitoring the Position of Aircraft Cabin Components

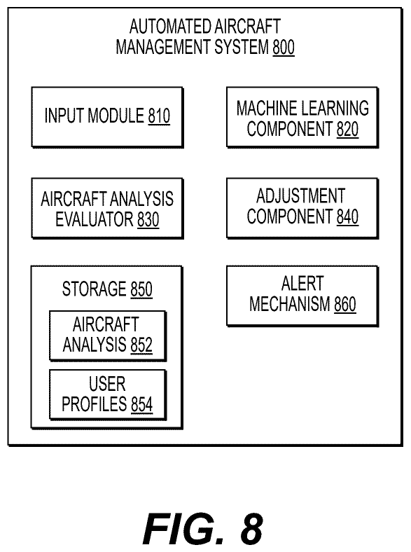

With reference to FIG. 10, a method 1000 for monitoring a position of cabin components is shown in accordance with embodiments of the present disclosure. The aircraft monitoring system 100 is configured to provide passenger safety monitoring using the imaging components 108 and cameras 112.

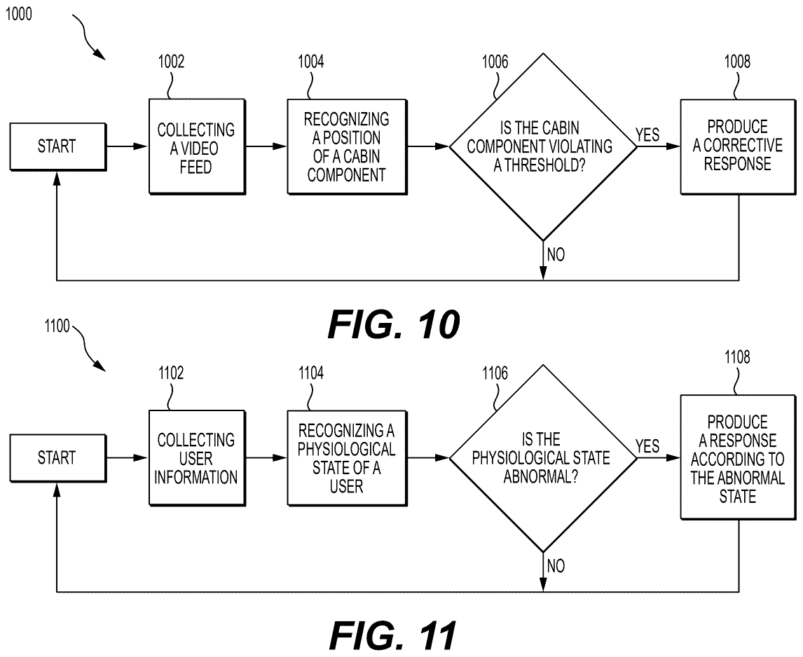

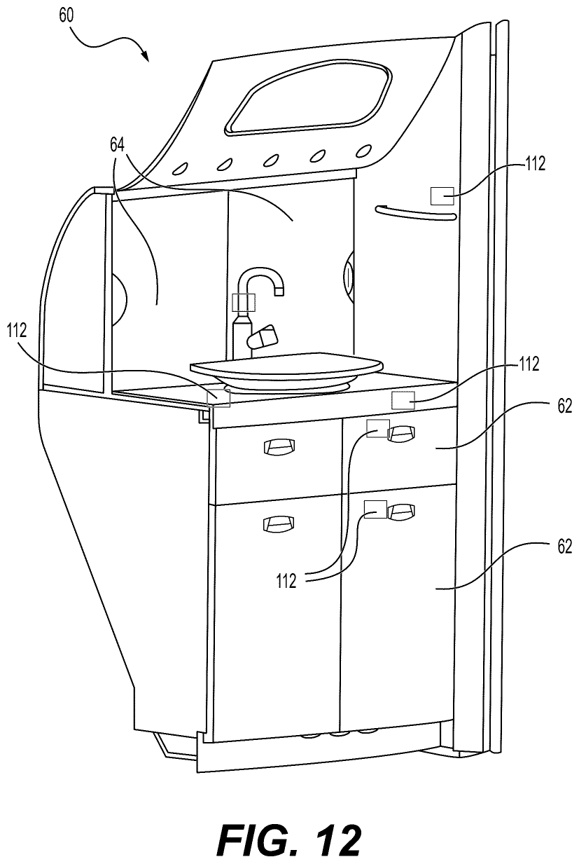

A block 1002 comprises, collecting a video feed. In embodiments, with reference to FIGS. 12 and 13, the data collection module 110, including the imaging components and cameras 112, is disposed throughout the aircraft cabin and collects a video feed of cabin components, objects, and monuments disposed within the aircraft cabin. More specifically, the imaging components 108 and cameras 112 may be directed towards an aircraft seat 170 or seats 600, a galley 60 including cabinets 64, drawers 62, closets, overhead bins, storage closets, or the like. In some embodiments, aircraft components are configured with electromechanical actuators 104 which provide powered movement for individual components. The electromechanical actuators 104 may be communicatively coupled to the monitoring system 100 and controller 130.

A block 1004 comprises, recognizing a position of a cabin component. In embodiments, the recognition module 140 is configured to recognize the position of the cabin components based on the collected video feed. For instance, with reference to FIG. 13, a position of a cabin component may be recognizing when an aircraft seat 170 is in an upright, reclined, rotated (aircraft seat 171), unrotated, or tracked to a fully forward or fully aft position. Another position of a cabin component may be whether cabin lighting is fully lit, off, or dimmed. Additionally, another position may be an aircraft galley 60 door, cupboard, or drawer 62 being in an open or closed position. In embodiments, the position of the aircraft component may be relative to stationary or static cabin components that are not configured to rotate, which may be walls, side ledges, or windows. In some embodiments, the recognition module 140 may utilize component contours and determine rotational baselines for opening/closing or rotating components.

A block 1006 comprises, determining whether or not the cabin component is violating a threshold. In embodiments, the decision-making component 120 is configured to determine if the cabin component is violating a threshold based on the position of the cabin component recognized by the recognition component 140. In some embodiments, the decision-making component is preloaded with thresholds corresponding to specific aircraft components. For instance, a threshold may be a degree of openness of an aircraft galley 60 component such as a drawer, cabinet, or door. In some embodiments, a threshold may be a barrier which indicates whether or not an aircraft component is interfering with an aircraft aisle, pathway, or walkway such as an emergency egress pathway 70. In other embodiments, a threshold may be contours of an aircraft component which correspond to a TTOL position of respective aircraft components (e.g., seat 170). In some embodiments, a threshold may be a distance differential between an aircraft component and stationary cabin elements, other cabin components, and passengers. In this way the threshold may be configured to prevent aircraft components from colliding with each other, stationary cabin elements, or passengers. If the cabin components do not violate a threshold the method 1000 proceeds back to the start.

A block 1008 comprises producing a corrective response when the cabin component violates the threshold. In embodiments, the corrective response corresponds to the aircraft component which has violated the threshold. The decision-making component 120 is configured to produce the corrective response and communicates instructions and commands to the controller 130 which controls the aircraft components. In embodiments, a corrective response may be a command for an electromechanical actuator 104 of an aircraft component to move the aircraft component out of a walkway/pathway 70. For instance, if the decision-making component 120 determines a drawer 62 violates a threshold which indicates that the drawer 62 is open and is interfering with an aircraft walkway (e.g. the drawer 62 being left open by a passenger) a corrective response may be to control the electromechanical actuator 104 of the drawer 62 to close the drawer. In another instance, the decision-making component 120 may determine a rotated aircraft seat 171 violates a threshold barrier which establishes the bounds of an aircraft pathway/emergency exit pathway 70 and indicates the rotated aircraft seat 171 is protruding into the pathway 70. A corrective response in this instance may be to provide commands to control the electromechanical actuator 104 to move the aircraft seat 171 out of the pathway 70. In some embodiments, a corrective response may be a command for an electromechanical actuator 104 to move an aircraft component into a TTOL position. For instance, when the aircraft is in a TTOL phase of flight and a door, cabinet, drawer 62, or overhead bin violates a threshold indicating that it is not in a TTOL position (e.g. it is open) a command may be communicated to controller 130 to move the door, cabinet 64, overhead bin, or drawer 62 into a TTOL position (e.g. close it). In another instance, the decision-making component 120 may determine the contours of an aircraft seat 170 violate a threshold indicating the aircraft seat 170 is not in a TTOL position and may produce commands to move the aircraft seat 170 into a TTOL position. In some embodiments, a corrective response may be locking an aircraft component in place and restricting the movement of the aircraft component. Locking or motion restriction may be a corrective response in instances where a collision with another aircraft component is imminent or when the aircraft is in a TTOL phase of flight. Locking or motion restriction may also be a corrective response when a passenger violates a threshold indicating the passenger is too close to an electromechanically controlled aircraft component. This may substantially prevent a passenger from becoming injured by movement of the aircraft component. It should be recognized that in embodiments when an aircraft seat 170 or aircraft galley 60 component such as a cabinet, drawer, bin, aircraft seat, or door is not configured with an electromechanical actuator 104 or an actuator that is not controllable using controller 130, a corrective response may be producing an alert which provides indication to personnel that an aircraft component is in a pathway 70 or not in a TTOL position. In some embodiments, a corrective response may be producing an alert which indicates baggage or another object is in an aircraft aisle or pathway 70. For instance, the decision-making component 120 may determine that baggage violates a threshold barrier for an aircraft pathway 70 and an alert may be produced to notify personnel that baggage is in an aircraft aisle or walkway and may interfere with an emergency exit pathway 70.

### A Method for Monitoring A Physiological State of a Passenger

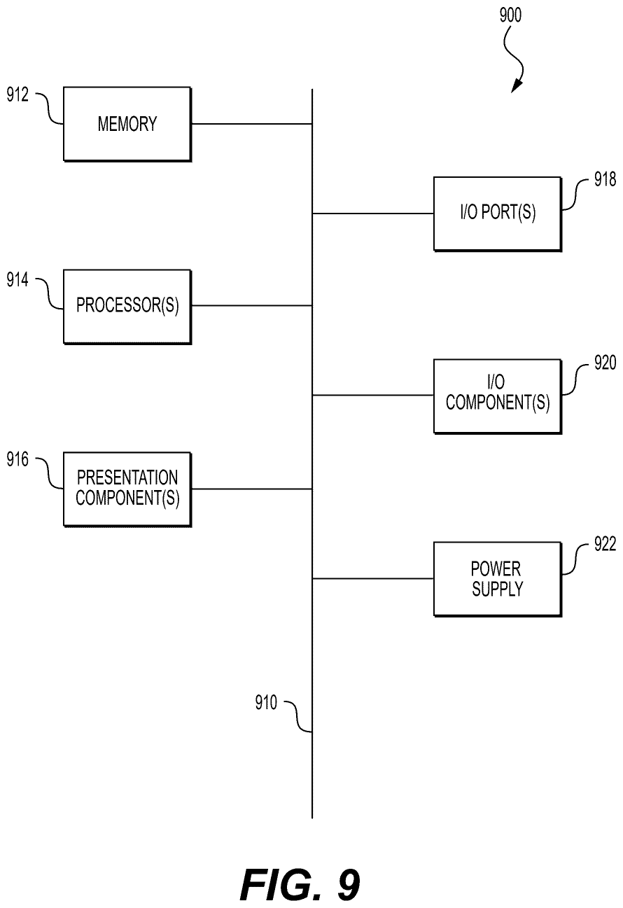

With reference to FIG. 11, a method 1100 for monitoring a physiological state of a user, (e.g., a passenger) is shown in accordance with embodiments of the present disclosure. The aircraft monitoring system 100 is configured to provide passenger safety monitoring using the imaging components 108 and cameras 112.

A block 1102 comprises, collecting a video feed, physical characteristics, and biometric information of one or more individuals in the aircraft cabin. In embodiments, the data collection module 110, including the imaging components 108 and cameras 112, is disposed throughout the aircraft cabin and collects a video feed and biometric and physical characteristics of one or more individuals onboard the aircraft. In embodiments, the imaging components 108 (see FIG. 13) may include radar, infrared, and photoplethysmography (PPG) sensing instruments. In some embodiments, the cameras 112 may be a PPG sensing instrument or part of a PPG sensing instrument. PPG instruments may be configured to measure light emission, light absorption, and waveform detection to provide biometric information of one or more individuals in an aircraft cabin. In embodiments, physical characteristics may include head position, eye position, and orientation of an individual onboard the aircraft. Other information such as skin tone, body temperature, micro-movements (e.g., chest expansion), facial movements/expressions, eye gaze, heart rate, respiratory rate, and other biometric detections may also be collected in step 1102.

A block 1104 comprises, recognizing a physiological state of a user. In embodiments (see FIG. 3), the recognition module 140 is configured to recognize a physiological state of a user 160 based on the video feeds, biometric information, and physical characteristics of a user 160. In embodiments, the recognition module 140 may recognize when a user 160 is fatigued or distressed based on breathing rate, posture, facial micro-expressions, and skin tone. In some embodiments, the recognition module 140 may recognize when user 160 is having a medical event. In some embodiments, the recognition module 140 may be preloaded with human biological information in order to recognize human physiological states corresponding to physical characteristics and biometric conditions. For instance, the recognition module 140 may recognize an elevated heart rate, a high body temperature, an elevated respiratory rate, or a nervous facial expression to recognize that a user 160 is in a distressed state or experiencing a medical event. In another instance, the recognition module 140 may recognize a slumped posture and recognize that a user 160 may be unconscious. In another instance, the recognition module 140 may recognize a slow heart rate, an even respiratory rate, closed eyes, or a relaxed facial expression to recognize a user 160 is fatigued or nearing a sleeping state.

A block 1106 comprises, determining whether or not the physiological state is abnormal. In embodiments, the decision-making component 120 is configured to determine whether or not the physiological state recognized by the recognition module 140 is abnormal. For instance, an abnormal physiological state may be if the user 160 is in a distressed state or is experiencing a medical event. As described above, an abnormal state may be recognized by an elevated heart rate, an abnormally high body temperature, an elevated respiratory rate, an abnormal facial expression, or a slumped posture (indicating unconsciousness). In some embodiments, the decision-making component 120 may be preloaded with human biological information in order to determine abnormal human physiological states corresponding to a recognized physiological state. If the physiological state is not abnormal, the method 1100 proceeds back to the start. A normal physiological state may be if the user 160 has normal skin tone, body temperature, and breathing rate. These may be associated with a relaxed or average physiological state.

A block 1108 comprises producing a response when the physiological state is determined to be abnormal in step 1106. In embodiments, the response corresponds to the abnormal physiological state. In embodiments, the response may be a notification or an alert, or may be an adjustment to an aircraft component or cabin setting. For instance, if the abnormal physiological state is indicative of a passenger experience, such as a medical event (e.g., heart attack, stroke, unconsciousness) an alert may be produced which provides notification to personnel that a user 160 needs immediate attention. In another instance, if the abnormal physiological state indicates a user 160 is distressed, the response may be producing an alert to notify personnel to provide assistance to a distressed user 160. Additionally, the response in this instance may be producing instructions and commands to adjust the temperature and the lighting of the aircraft cabin to make the user 160 more comfortable. In another instance, if the abnormal physiological state indicates a user 160 is asleep, the response may be producing commands and instructions to dim cabin lights and adjust an aircraft seat 170 to a position more comfortable for the user 160.

### A Method for Monitoring a Pilot and Improving Pilot Comfort

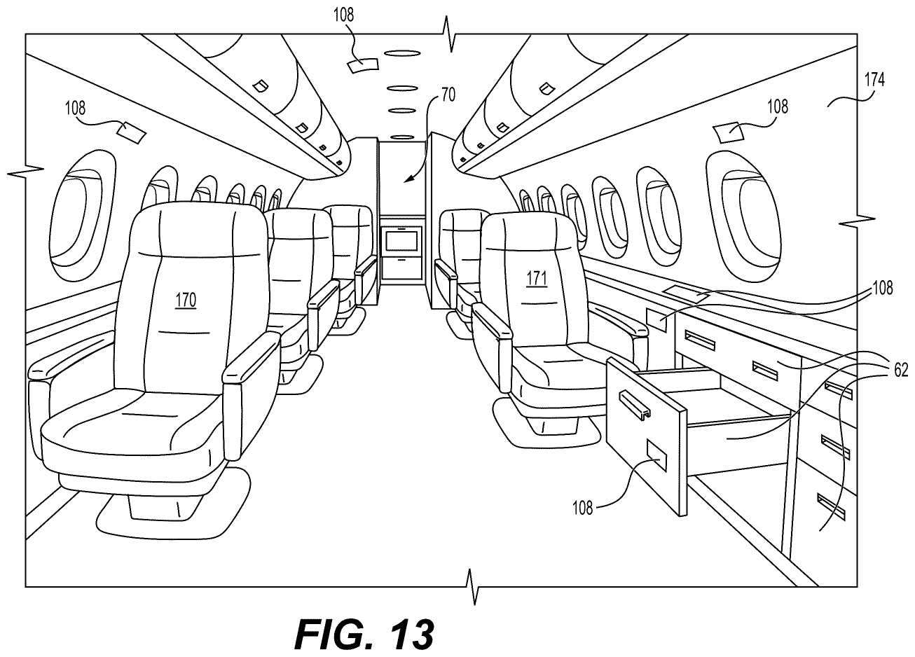

With reference to FIG. 14 a method for monitoring a pilot and improving pilot comfort is shown in accordance with embodiments of the present disclosure. The aircraft monitoring system 100 is configured to optimize the comfort of a pilot using the imaging components 108 and cameras 112.

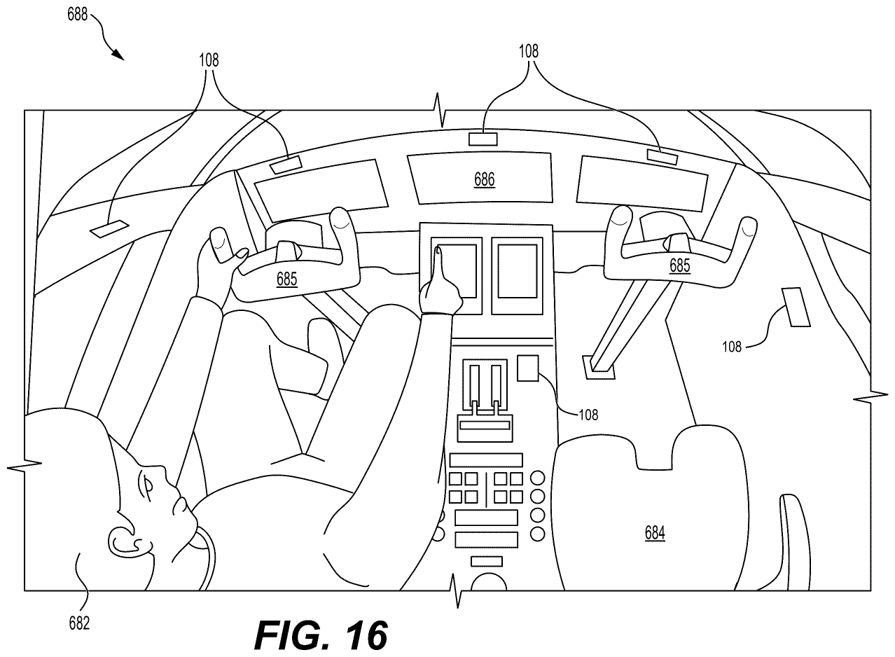

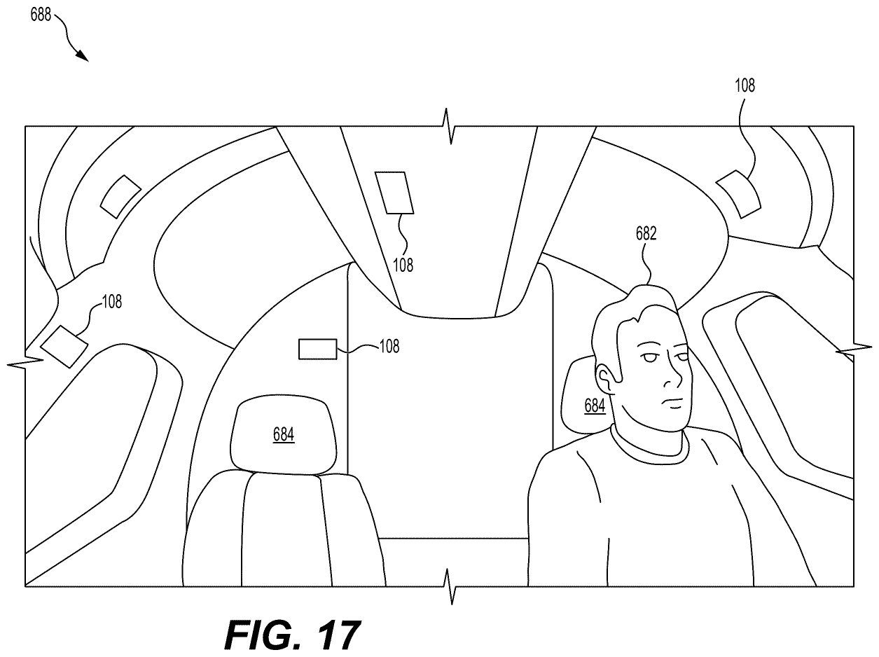

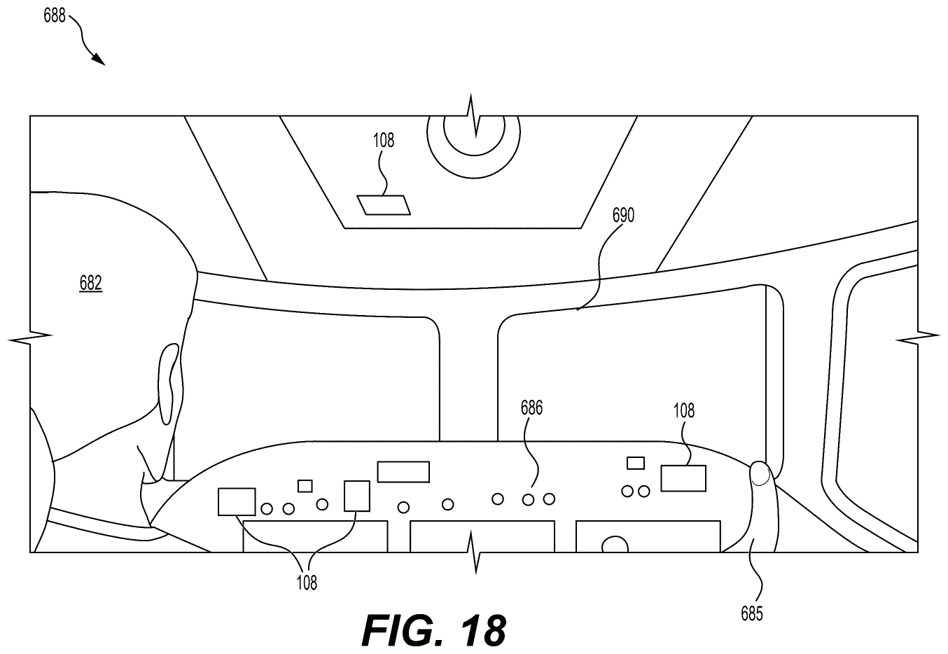

A block 1402 comprises, collecting information corresponding to a pilot and an aircraft cockpit area. In embodiments, with reference to FIGS. 16-18 the data collection module 110, including imaging components 108 and cameras 112, is disposed throughout an aircraft cockpit area 688 and collects a video feed and biometric and physical characteristics of a pilot or co-pilot 682 within the cockpit 688. In embodiments, the imaging components 108 may include radar, infrared, and photoplethysmography (PPG) sensing instruments. In some embodiments, the cameras 112 may be a PPG sensing instrument or part of a PPG sensing instrument. PPG instruments may be configured to measure light emission, light absorption, and waveform detection to provide biometric information of a pilot or co-pilot 682 in an aircraft cockpit 688. In embodiments, physical characteristics may include head position, eye position/gaze, and posture of a pilot in a cockpit seat 684. Other information such as skin tone, body temperature, micro-movements (e.g., chest expansion), facial movements/expressions, eye gaze, heart rate, respiratory rate, and other biometric detections may also be collected in step 1402. In embodiments the imaging components 108 and cameras 112 are configured to collect information corresponding to an aircraft cockpit area 688 such as the body posture of the pilot 682 relative to cockpit elements such as a yoke 685 and control panel 686. The imaging components 108 and cameras 112 are also configured to collect information corresponding to a cockpit temperature and lighting.

A block 1404 comprises, recognizing a body position or posture and a physiological state of a pilot. In embodiments, the recognition module 140 is configured to recognize a physiological state of a pilot 682 based on the video feeds, biometric information, physical characteristics, and environmental conditions of the pilot 682 and the aircraft cockpit area 688. In embodiments, the recognition module 140 may recognize a pilot's posture or body position relative to an aircraft control display 686 or aircraft cockpit components such as a yoke 685, steering column, or joystick. In some embodiments, the recognition module 140 may recognize the eye gaze of a pilot 682 and the lighting and temperature of the aircraft cockpit environment 688. In some embodiments, the recognition module 140 may recognize when the pilot 682 is demonstrating unsafe behavior. In some embodiments, an unsafe behavior may be recognizing if the pilot 682 is distracted or excessively distracted (e.g., by possibly a personal electronic device, media, etc.). In other embodiments, an unsafe behavior may mean the pilot 682 is deviating from standard operating procedures imposed by a flight department. In some implementations, the recognition module 140 may include foreign object detection capabilities. In some embodiments, the recognition module 140 may be preloaded with thresholds and postures which are comfortable for a pilot 682 while piloting the aircraft.

A block 1406 comprises, determining whether or not the comfort of the pilot can be improved. In embodiments, the decision-making component 120 is configured to determine whether or not the body position and physiological state of the pilot 682 can be changed to improve comfort of the pilot 682. For instance, the comfort of the pilot 682 may be improved when the body position or posture of pilot 682 is recognized and the decision-making component 120 determines the posture or body position of the pilot is not comfortable based on the position of the cockpit seat 684 or not comfortable for controlling a yoke 685, or interacting with a flight control panel 686. In some embodiments, the comfort of a pilot 682 may be improved when the decision-making component 120 determines the eye gaze of a pilot 682 is being impacted by external light entering into the cockpit area 688. In some embodiments, the comfort of a pilot 682 may be improved when the decision-making component 120 determines the body temperature of the pilot 682 is too warm or too cold or the temperature of the aircraft cockpit area 688 is too warm or too cold. If at block 1406, the pilot 682 is comfortable the method 1400 proceeds back to the start. The pilot 682 may be comfortable when the decision-making component 120 determines that a body position of the pilot 682 relative to the yoke 685 and control panel 686 is comfortable and the physiological data indicates normal levels of a pilot's body temperature, breathing rate, etc.

A block 1408 comprises, producing a response when the comfort of the pilot may be improved. In embodiments, the response corresponds to improving comfort of the pilot 682 as determined by the decision-making component 120 at block 1406. For instance, the decision-making component 120 may determine the comfort of the pilot 682 may be improved by adjusting the cockpit seat 684 to allow the pilot 682 to have a more comfortable body position or posture. In some embodiments, the response may be commands directed to an electromechanical actuator 104 configured to control the cockpit seat 684. In some embodiments, the response may be visual or auditory cues to assist the pilot 682 in adjusting the cockpit seat 684 to achieve a more comfortable body position or posture. In another instance, a response may be deploying window tint or visors 690 to block light from entering the cockpit area 688. For instance, the recognition module 140 may recognize eye gaze of a pilot and the decision-making component 120 may determine light is interfering with a pilot's vision which is causing a pilot 682 to squint which is uncomfortable. In this instance, the decision-making component 120 may produce commands to control an electromechanical actuator 104 which adjusts visors 690 or window tint to block light, reduce glare, and improve pilot 682 vision and comfort. In some embodiments, the visors 690 may be a transparent dimmable window film configured to reduce the amount of light or glare entering a cockpit (e.g., a locally dimmable film or transparent film). In another instance, the response may be adjusting air vents for improving the thermal comfort of the pilot 682. For instance, the recognition module 140 may recognize a physiological state of a pilot 682, which includes body temperature, and the decision-making component 120 may determine pilot 682 comfort can be improved by adjusting a cockpit temperature and adjusting an air vent. The decision-making component 120 can produce commands for controlling an electromechanical actuator 104 for adjusting one or more air vents to direct airflow for improved thermal comfort. It should be recognized that in instances where an air vent, cockpit seat 684, visor 690, or window tint is not configured with an electromechanical actuator 104 controllable by controller 130, a response may be producing a notification indicating a cockpit component (e.g. seat, yoke, etc.) and a corresponding suggested adjustment which can be manually implemented for improving pilot 682 comfort.

### A Method for Monitoring a Pilot and Improving Aircraft Safety

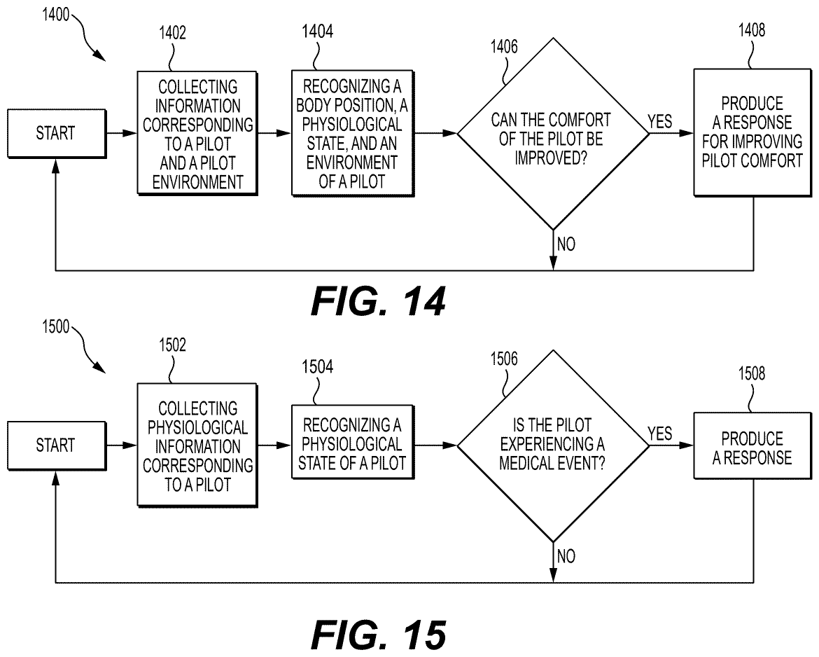

With reference to FIG. 15, a method 1500 for monitoring a physiological state of a pilot is shown in accordance with embodiments of the present disclosure. The aircraft monitoring system 100 is configured to provide pilot monitoring for safety of the pilot and the aircraft.

A block 1502 comprises, collecting physiological information corresponding to a pilot. In embodiments, with reference to FIGS. 16-18, the data collection module 110, including the imaging components 108 and cameras 112, is disposed throughout the aircraft cockpit area 688 and collects a video feed and biometric and physical characteristics of a pilot or co-pilot 682 in the cockpit 688. In embodiments, the imaging components 108 may include radar, infrared, and photoplethysmography (PPG) sensing instruments. In some embodiments, the cameras 112 may be a PPG sensing instrument or part of a PPG sensing instrument. PPG instruments may be configured to measure light emission, light absorption, and waveform detection to provide biometric information of one or more pilots in a cockpit 688. In embodiments, physical characteristics may include head position, eye position, and orientation of a pilot within the cockpit. Other information such as skin tone, body temperature, micro-movements (e.g., chest expansion), facial movements/expressions, eye gaze, heart rate, respiratory rate, and other biometric detections may also be collected in step 1502. In some embodiments, the pilot physiological information may be stored in a database for subsequent analysis. In this way, video feeds and physiological information may be used for performance coaching and investigative purposes.

A block 1504 comprises, recognizing a physiological state of a pilot. In embodiments, with reference to FIGS. 16-18, the recognition module 140 is configured to recognize a physiological state of a pilot 682 based on the video feeds, biometric information, and physical characteristics collected in block 1502. In embodiments, the recognition module 140 may recognize when a pilot 682 is drowsy, fatigued, or inattentive based on breathing rate, posture, facial micro-expressions, and skin tone. In some embodiments, the recognition module 140 may recognize when the pilot 682 is experiencing an impending or an ongoing medical event or is incapacitated. In some embodiments, the recognition module 140 may be preloaded with human biological information in order to recognize human physiological states corresponding to physical characteristics and biometric conditions displayed by the pilot 682. For instance, the recognition module 140 may recognize an elevated heart rate, a high body temperature, an elevated respiratory rate, or a nervous facial expression to recognize that the pilot 682 is in a distressed state or is experiencing a medical event. In another instance, the recognition module 140 may recognize a slumped posture and recognize that the pilot 682 is unconscious. In this disclosure, it should be recognized that a medical event may be any event which renders a pilot or co-pilot unable to perform necessary duties to pilot the aircraft. This may include but is not limited to heart attack, stroke, unconsciousness, panic attacks, or the like. In another instance, the recognition module 140 may recognize a slow heart rate, a relaxed/normal respiratory rate, closed eyes, or a relaxed facial expression to recognize a pilot 682 is inattentive or drowsy.

A block 1506 comprises, determining whether or not the pilot is experiencing an ongoing or an impending medical event. In embodiments, the decision-making component 120 is configured to determine whether or not the physiological state recognized by the recognition module 140 is indicative of a current or ongoing medical event. As described above, an impending or ongoing medical event may be characterized by an elevated heart rate, an abnormally high body temperature, an elevated respiratory rate, an abnormal facial expression, or a slumped posture (indicating unconsciousness). In some embodiments, the decision-making component 120 may be preloaded with human biological information in order to determine abnormal human physiological states corresponding to a recognized physiological state. If the physiological state is not indicative of the pilot 682 experience a medical event, the method 1500 proceeds back to the start. A normal physiological state may be if the user 160 has normal skin tone, body temperature, and breathing rate. These may be associated with average physiological readings or detections of the pilot 682.

A block 1508 comprises producing a response when the pilot 682 is determined to be experiencing a medical event in block 1506. In embodiments, the response may be a notification, alert, or initiation of an emergency autoland function without requiring manual intervention. For instance, if the physiological state is indicative of pilot 682 experiencing an impending or ongoing medical event (e.g., heart attack, stroke, unconsciousness) an alert may be produced which provides notification to personnel that a pilot 682 needs immediate attention. In embodiments, when the physiological state of both pilots (or a co-pilot and a pilot) indicates that both pilots are experiencing an impending/ongoing medical event or are both incapacitated, the decision-making component 120 may produce commands to the controller 130 for engaging an emergency autoland function. In this way, manual or human initiation of the emergency autoland function is not required. This is advantageous because the autoland function may be initiated quicker than manual initiation so that the aircraft is not flying uncontrolled when both pilots are incapacitated.

### Example Operating Environment

Having described an overview of embodiments of the present technology, an example operating environment in which embodiments of the present technology may be implemented is described in order to provide a general context for various aspects of the present technology. Referring now to FIG. 9, in particular, an exemplary operating environment for implementing embodiments of the present technology is shown and designated generally as computing device 900. Computing device 900 is but one example of a suitable computing environment and is not intended to suggest any limitation as to the scope of use or functionality of the technology. Neither should computing device 900 be interpreted as having any dependency or requirement relating to any one or combination of components illustrated. In embodiments, computing device 900 may be included in controller 130 or controller 620.

The technology of the present disclosure may be described in the general context of computer code or machine-useable instructions, including computer-executable instructions such as program modules, being executed by a computer or other machines, such as a personal data assistant or other handheld devices. Generally, program modules, including routines, programs, objects, components, data structures, etc., refer to code that performs particular tasks or implements particular abstract data types. The technology may be practiced in a variety of system configurations, including handheld devices, consumer electronics, general-purpose computers, more specialty computing devices, etc. The technology may also be practiced in distributed computing environments where tasks are performed by remote-processing devices that are linked through a communications network.

With reference to FIG. 9, computing device 900 includes bus 910 that directly or indirectly couples the following devices: memory 912, one or more processors 914, one or more presentation components 916, input/output ports 918, input/output components 920, and illustrative power supply 922. Bus 910 represents what may be one or more buses (such as an address bus, data bus, or combination thereof). Although the various blocks of FIG. 9 are shown with lines for the sake of clarity, in reality, delineating various components is not so clear, and metaphorically, the lines would more accurately be grey and fuzzy. For example, one may consider a presentation component, such as a display device, or an I/O component. Also, processors have memory. We recognize that such is the nature of the art and reiterate that the diagram of FIG. 9 merely illustrates an example computing device that can be used in connection with one or more embodiments of the present technology. A distinction is not made between such categories as “workstation,” “server,” “laptop,” “handheld device,” etc., as all are contemplated within the scope of FIG. 9 and reference to “computing device.”

Computing device 900 typically includes a variety of computer-readable media. Computer-readable media can be any available media that can be accessed by computing device 900 and includes both volatile and nonvolatile media, removable and non-removable media. By way of example, and not limitation, computer-readable media may comprise computer storage media and communication media.

Computer storage media can include volatile and nonvolatile, removable, and non-removable media implemented in any method or technology for storage of information, such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information, and which can be accessed by computing device 900. Computer storage media excludes signals per se.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 912 includes computer storage media in the form of volatile or nonvolatile memory. The memory may be removable, non-removable, or a combination thereof. Examples of hardware devices include solid-state memory, hard drives, optical-disc drives, etc. Computing device 900 includes one or more processors that read data from various entities, such as memory 912 or I/O components 920. Presentation component(s) 916 presents data indications to a user or other device. Examples of presentation components include a display device, speaker, printing component, vibrating component, etc.

I/O ports 918 allow computing device 900 to be logically coupled to other devices, including I/O components 920, some of which may be built in. Illustrative components include a microphone, joystick, game pad, satellite dish, scanner, printer, wireless device, etc.

Having identified various components in the present disclosure, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions, etc.) can be used in addition to or instead of those shown.

The subject matter of the present disclosure is described with specificity herein to meet statutory requirements. However, the description itself is not intended to limit the scope of this patent. Rather, the inventor has contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described. For purposes of this disclosure, words such as “a” and “an,” unless otherwise indicated to the contrary, include the plural as well as the singular. Thus, for example, the requirement of “a feature” is satisfied where one or more features are present.

The present disclosure has been described in relation to particular embodiments, which are intended in all respects to be illustrative rather than restrictive. Alternative embodiments will become apparent to those of ordinary skill in the art to which the present disclosure pertains without departing from its scope.

From the foregoing, it will be seen that this disclosure is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. An aircraft monitoring system, the system comprising:
a user interface disposed onto an interior aircraft surface;
a data collection module comprising a plurality of imaging components disposed throughout an aircraft and configured to collect input data corresponding to the user interface, the aircraft, or an individual onboard the aircraft;
a recognition module configured to receive the input data and recognize an action of the individual directed towards the user interface;
a decision-making component configured to determine an adjustment based on the action recognized by the recognition module; and
a controller communicatively connected to one or more aircraft components, wherein the controller is configured to receive a command for the adjustment and provide instructions to implement the adjustment to the one or more aircraft components.

2. The system of claim 1, wherein the data collection module includes a plurality of cameras configured to collect a video feed and an audio component configured to detect and record audio onboard the aircraft.

3. The system of claim 1, wherein when the input data includes a gesture of the individual performed in an aircraft cabin, the recognition module recognizes the gesture and makes a prediction corresponding to the gesture, and the decision-making component determines an adjustment based on the prediction.

4. The system of claim 3, wherein the gesture is a pressing motion directed to an icon disposed on an aircraft seat and the recognition module predicts the pressing motion is an action directed towards the icon.

5. The system of claim 4, wherein the input data includes a seat position of the aircraft seat and the decision-making component determines the adjustment based on the pressing motion and the seat position of the aircraft seat.

6. The system of claim 2, wherein the plurality of cameras are directed towards an icon embroidered onto a surface of an aircraft interior.

7. A method for monitoring an aircraft, the method comprising:
collecting data associated with an aircraft using a data collection module, wherein the data collection module comprises a plurality of cameras disposed throughout the aircraft and configured to collect a video feed;
recognizing an action of an individual directed towards a user interface, wherein the user interface is disposed on an aircraft interior surface;
determining an adjustment based on the action directed towards the user interface, wherein the adjustment corresponds to adjusting an aircraft component; and
implementing the adjustment to the aircraft component, the step of implementing comprising:
receiving a command for the adjustment, and
providing instructions to implement the adjustment to the aircraft component.

8. The method of claim 7, comprising determining the adjustment by identifying the individual onboard the aircraft and referencing a user history associated with the individual.

9. The method of claim 7, comprising recognizing a behavior of the individual by detecting a head position, appendage position, posture, expression, or eye position of the individual.

10. The method of claim 9, comprising determining an adjustment based on the behavior and the adjustment corresponds to adjusting an aircraft cabin setting.

11. The method of claim 9, comprising computing a distance differential between a fingertip of the individual and the user interface.

12. The method of claim 11, comprising preloading a threshold distance between the fingertip of the individual and the user interface to determine when the individual directs an action towards the user interface.

13. The method of claim 12, comprising recognizing a gesture directed to the user interface when the threshold distance is violated by the fingertip of the user.

14. The method of claim 7, comprising:
recognizing coordinates of fingertip points on a 2-D plane;
generating a depth map using the video feed of the data collection module; and
appending depth data points to the fingertip points on the depth map.

15. The method of claim 7, comprising:
collecting audio and detecting audible words of the individual;
recognizing when the audible words correspond to the aircraft component; and
determining an adjustment to the aircraft component based on the audible words.

16. A method for aircraft monitoring, the method comprising:
disposing a data collection module throughout an aircraft wherein the data collection module comprises a plurality of cameras;
disposing a plurality of user interfaces throughout the aircraft, wherein the cameras are configured to monitor the plurality of user interfaces;
wherein the plurality of cameras provide a video feed and a recognition module generates a depth map of a region surrounding at least one of the user interfaces, and the depth map provides a distance differential representative of a distance between a body part of an individual onboard the aircraft and the user interface, such that when the distance differential changes an action of the individual directed towards the user interface is detected.

17. The method of claim 16, wherein the data collection module is preloaded with visual tolerance levels to estimate location and position of objects within the depth map.

18. The method of claim 16, wherein the data collection module is preloaded with presets corresponding to unusual objects including gloves, coats, children, or dirt.

19. The method of claim 16, wherein the user interface is disposed on an aircraft seat or an aircraft galley.

20. The method of claim 16, wherein the user interface is a target mimicking a press button, wherein the target is disposed on an aircraft interior surface and change in the distance differential results from a user making a swiping motion towards the target.
